(19) United States
(12) Patent Application Publication
(10) Pub. No.: US 2025/0327679 A1
(43) Pub. Date: Oct. 23, 2025

(54) INFORMATION PROCESSING DEVICE, INFORMATION PROCESSING METHOD, AND PROGRAM

(71) Applicant: Nissan Motor Co., Ltd., Kanagawa (JP)

(72) Inventor: Shota Okubo, Kanagawa (JP)

(73) Assignee: Nissan Motor Co., Ltd., Kanagawa (JP)

(21) Appl. No.: 18/868,531

(22) PCT Filed: Mar. 6, 2023
(86) PCT No.: PCT/JP2023/008324

§ 371 Date: Nov. 22, 2024

(30) Foreign Application Priority Data
May 31, 2022 (JP) 2022-088968

(51) Int. Cl. G01C 21/36; A63B 24/00; A63B 71/06; G01C 21/34

(52) U.S. Cl. CPC G01C 21/3617; A63B 24/0059; A63B 24/0062; A63B 71/0622; G01C 21/3492; G01C 21/3694; A63B 2024/0068; A63B 2071/0691; A63B 2220/70

(57) ABSTRACT

The management server executes a dispatching processing for the user. The management server comprises a communication unit that receives at least one of the departure place and the destination from the user, a control unit that sets the boarding place and disembarking place of the vehicle assigned to the user based on at least one of the received departure place and destination, and a communication unit that outputs the boarding place and disembarking place to the user. The control unit sets at least one of a first exercise section, in which the user moves while doing exercise with the boarding place as an end point, and a second exercise section, in which the user moves while doing exercise with the disembarking place as a start point, based on movement information related to the user.

### TECHNICAL FIELD

The present invention relates to an information processing device, an information processing method, and a program that execute vehicle dispatch processing.

### BACKGROUND ART

In related art, there is a technique for providing a moving means when a user moves. For example, there has been proposed a traffic system in which a general vehicle is prohibited from getting into a housing estate and a user moves by an electric vehicle along a traveling path in the housing estate and moves by changing to the general vehicle outside the housing estate (see, for example, JP2002-133577A).

### SUMMARY OF INVENTION

In the related art, it is possible to move while boarding an electric vehicle in the housing estate, and to move by changing to a general vehicle outside the housing estate. In this way, since the user can move by vehicle, the user can quickly move. However, if the user continues to use the vehicle at the time of movement, there is a concern that an opportunity to exercise by the movement is reduced and the exercise is insufficient.

An object of the present invention is to implement vehicle dispatch processing capable of achieving both convenience of movement and health of a user.

An aspect of the present invention is an information processing device that executes vehicle dispatch processing for a user. The information processing device includes: a reception unit configured to receive at least one of a departure place and a destination from the user; a control unit configured to set, based on at least one of the received departure place and the received destination, a boarding place and a disembarking place related to a vehicle to be assigned to the user; and an output unit configured to output the boarding place and the disembarking place to the user. The control unit sets, based on exercise information related to the user, at least one of a first exercise section in which the user moves while doing exercise with the boarding place as an end point and a second exercise section in which the user moves while doing exercise with the disembarking place as a start point.

### BRIEF DESCRIPTION OF DRAWINGS

FIG. 1 is a simplified block diagram illustrating a system configuration example of an information processing system.

FIG. 2 is a block diagram illustrating a functional configuration example of an electronic device and a management server.

FIG. 3 is a simplified diagram of stored contents of an exercise information DB stored in a storage unit.

FIG. 4 is a simplified diagram illustrating a relationship between a vehicle moving section and a walking section set according to a vehicle dispatch reservation.

FIG. 5 is a diagram illustrating a display example of a vehicle dispatch reservation screen displayed on an input and output unit when a vehicle dispatch application is launched in the electronic device.

FIG. 6 is a diagram illustrating a display example in which information related to an exercise amount of a user is displayed on an approval screen.

FIG. 7 is a diagram illustrating a display transition example in which a plurality of route candidates are displayed on a plurality of screens.

FIG. 8 is a diagram illustrating a display example of achievement information displayed when a user who has used a vehicle dispatch service walks through the walking section.

FIG. 9 is a diagram illustrating a display example of achievement information displayed when the user who has used the vehicle dispatch service walks through the walking section.

FIG. 10 is a diagram illustrating a display example of achievement information displayed when the user who has used the vehicle dispatch service walks through the walking section.

FIG. 11 is a diagram illustrating a display example of achievement information displayed when the user who has used the vehicle dispatch service walks through the walking section.

FIG. 12 is a flowchart showing an example of vehicle dispatch processing in the management server.

FIG. 13 is a flowchart showing an example of achievement information output processing in the management server.

FIG. 14 is a diagram illustrating a transition example when a setting content at the time of vehicle dispatch reservation is changed based on congestion information.

FIG. 15 is a diagram illustrating a display example of a walking section setting screen displayed on the input and output unit when congestion occurs near a disembarking place.

FIG. 16 is a flowchart illustrating an example of route resetting processing in the management server.

FIG. 17 is a diagram illustrating an example when a service content of the vehicle dispatch service is changed based on an environment or the like.

### DESCRIPTION OF EMBODIMENTS

Hereinafter, an embodiment of the present invention will be described with reference to the accompanying drawings.

### Configuration Example of Information Processing System

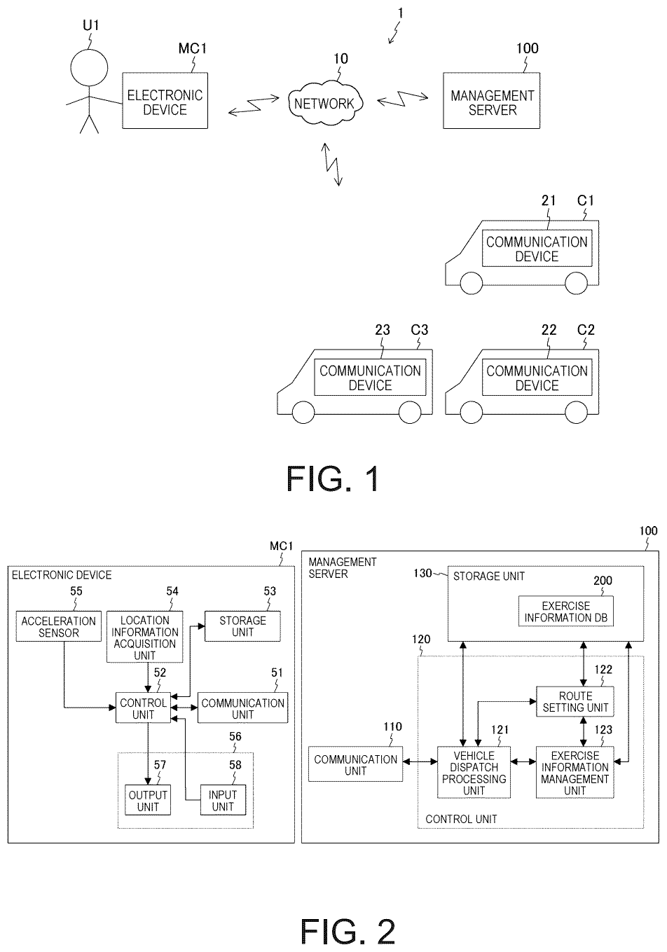

FIG. 1 is a simplified block diagram illustrating a system configuration example of an information processing system 1. The information processing system 1 is a communication system that provides a vehicle dispatch service. It is assumed that a user U1 is a user who carries an electronic device MC1 and uses the vehicle dispatch service. FIG. 1 illustrates an example in which one electronic device MC1 exists for ease of description, but the present invention is not limited thereto. The information processing system 1 may include two or more electronic devices. FIG. 1 illustrates an example in which three vehicles C1 to C3 exist, but the present invention is not limited thereto. The information processing system 1 may include one, two, or four or more types of vehicles.

The information processing system 1 includes a plurality of devices connected via a network 10. For example, the electronic device MC1, communication devices 21 to 23, and a management server 100 are connected via the network 10. The communication among the devices is performed using wired communication or wireless communication. In addition, the communication among the devices may be directly performed other than via the network 10.

The network 10 is a network such as a public line network or the Internet. Each device constituting the information processing system 1 is connected to the network 10 by either a communication method using wireless communication or a communication method using wired communication, or by both methods.

The electronic device MC1 is a portable device that can be carried by the user U1, and is capable of communicating with other devices using wireless communication or wired communication. Examples of the electronic device MC1 include various electronic devices and information processing device such as a smartphone, a mobile phone, a portable personal computer, a tablet terminal, and a wearable terminal. The wearable terminal is a device that can be used in a state of being worn on clothes or a body of the user U1, and includes a health tracker that acquires exercise information of the user. Examples of the wearable terminal include a wristwatch-type device and a headphone-type device. The wearable terminal may be worn by the user U1 as a device different from the electronic device MC1, and various kinds of information such as exercise information may be exchanged between the wearable terminal and the electronic device MC1.

A vehicle dispatch application used for vehicle dispatch reservation of the vehicles C1 to C3 is installed in the electronic device MC1, and the user U1 can make a vehicle dispatch reservation of the vehicles C1 to C3 using the vehicle dispatch application. The vehicle dispatch application provides a user interface when the vehicle dispatch reservation of the vehicles C1 to C3 is made.

The vehicles C1 to C3 are vehicles, such as taxis, that can move from a boarding place to a disembarking place based on instructions from the management server 100, and are equipped with communication devices 21 to 23 that can communicate with the management server 100 via the network 10. As the vehicles C1 to C3, for example, an autonomous driving vehicle without a driver and a normal vehicle with a driver can be used. The autonomous driving vehicle without the driver may be referred to as a robot taxi or an unmanned taxi.

The management server 100 is an information processing device used for the vehicle dispatch service of the vehicles C1 to C3, and executes various types of processing related to the vehicle dispatch reservation of the vehicles C1 to C3. The management server 100 communicates with the electronic device MC1 and the communication devices 21 to 23 via the network 10. An installation place of the management server 100 is not particularly limited. For example, the management server 100 is installed in a management center of a business operator that operates the vehicles C1 to C3. In the present embodiment, an example is illustrated in which the management server 100 executes all the vehicle dispatch processing, but the management server 100 may transmit information related to the vehicle dispatch to another server, and the server may execute at least a part of the vehicle dispatch processing.

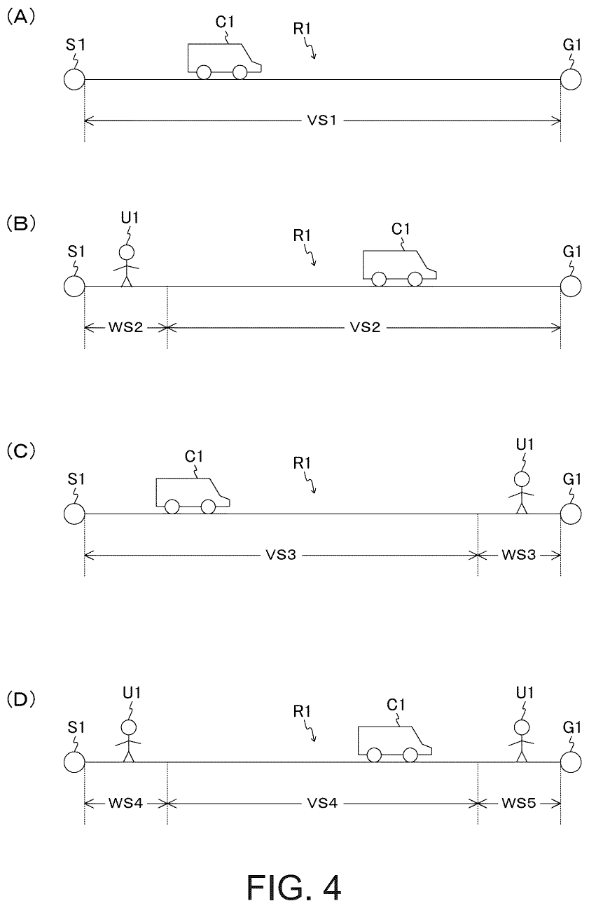

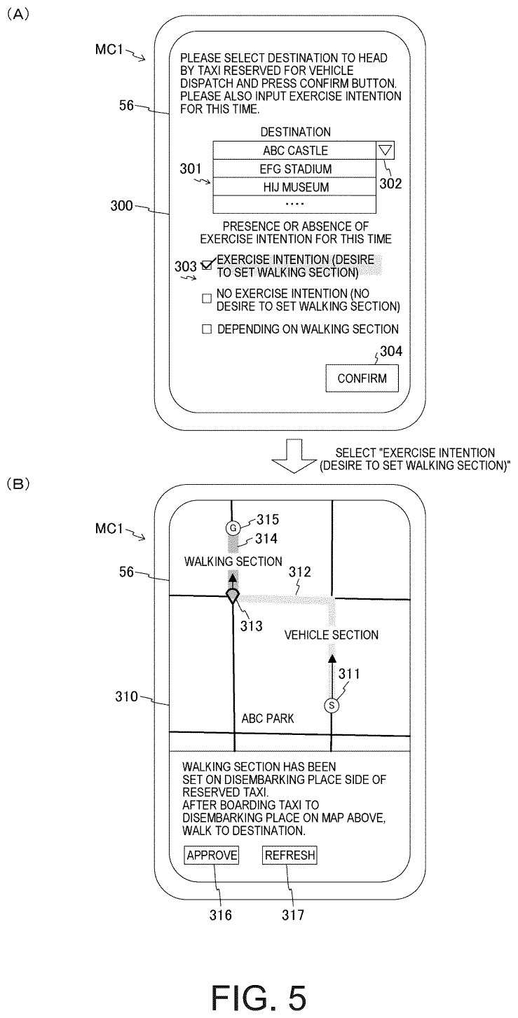

For example, when the user U1 performs a vehicle dispatch reservation operation using the vehicle dispatch application of the electronic device MC1, the management server 100 receives information (a vehicle dispatch request) relating to the vehicle dispatch reservation, and executes vehicle dispatch processing relating to the vehicle dispatch reservation. In this case, the management server 100 sets, based on a current place of the user U1, a boarding place (a place close to the current place) where the user U1 boards a vehicle, and sets, based on a destination specified by the user U1, a disembarking place (a place close to the destination) where the user U1 disembarks from the vehicle. As described above, the information processing system 1 can be an on-demand system in which the management server 100 matches a boarding or disembarking place in accordance with the current place and the destination of the user U1 from a plurality of boarding or disembarking places set in each place (for example, in a street). The information processing system 1 realizes a transportation service in which the user U1 boards one of the vehicles C1 to C3 at a boarding place set by the management server 100 and heads to a destination. In addition to a preset boarding or disembarking place, any place may be set as the boarding or disembarking place. A method of setting a boarding or disembarking place will be described in detail with reference to FIGS. 4 and 5.

Here, the user U1 can quickly move from a vicinity of the current place to a vicinity of the destination while boarding the vehicles C1 to C3. However, when the user U1 continues to use the vehicles C1 to C3 at the time of movement, there is a concern that an opportunity to exercise by the movement is reduced and the exercise is insufficient. Further, when the user U1 continues to move on foot, an opportunity to exercise by the movement increases, but there is a concern that quick movement becomes difficult. Therefore, in the present embodiment, when the user U1 moves using the vehicle dispatch service, the walking section is set as necessary, and the opportunity to walk is increased to eliminate the lack of exercise. Accordingly, it is possible to achieve both the convenience of movement and the health of the user, and it is possible to enhance the richness of the user U1 who is in life using the vehicle.

### Functional Configuration Examples of Management Server and Electronic Device

FIG. 2 is a block diagram illustrating functional configuration examples of the management server 100 and the electronic device MC1.

### Functional Configuration Example of Server

The management server 100 includes a communication unit 110, a control unit 120, and a storage unit 130. In the management server 100, these components are electrically connected via a bus (not shown) or the like. A general-purpose computer or a dedicated computer may be used as the management server 100.

Under the control of the control unit 120, the communication unit 110 exchanges various types of information with other devices using one of wired communication or wireless communication. In this way, the communication unit 110 functions as an input unit, a reception unit, and an output unit for transmitting and receiving data. As the communication unit 110, hardware such as a network adapter, various types of communication software, and a combination thereof can be used.

The control unit 120 controls each unit based on various programs stored in the storage unit 130. The control unit 120 is implemented by, for example, a processing device such as a central processing unit (CPU).

The control unit 120 includes a vehicle dispatch processing unit 121, a route setting unit 122, and an exercise information management unit 123 as functional components related to the vehicle dispatch processing.

Upon receiving a vehicle dispatch request transmitted from the electronic device MC1 in response to the vehicle dispatch reservation operation of the user U1, the vehicle dispatch processing unit 121 executes various vehicle dispatch processing according to the vehicle dispatch request. The vehicle dispatch request includes location information related to a current place of the user U1, location information related to a destination, exercise intention information related to an exercise intention, and a user ID. Each piece of location information includes, for example, latitude, longitude, and altitude.

The vehicle dispatch processing unit 121 outputs the location information (the user ID, the location information for specifying the current place of the user U1, and the location information for specifying the destination) included in the vehicle dispatch request to the route setting unit 122 and the exercise information management unit 123.

The route setting unit 122 uses an exercise information DB 200 and a map DB of the storage unit 130 to extract candidates of a movement route of the user U1 corresponding to the vehicle dispatch reservation based on the location information (the location information related to the current place of the user U1 and the location information related to the destination) output from the vehicle dispatch processing unit 121. For example, the route setting unit 122 sets boarding or disembarking places closest to the current place of the user U1 to the boarding place, sets a boarding or disembarking place closest to the destination of the user U1 to the disembarking place, and searches for a route (a vehicle moving section) from the boarding place to the disembarking place. For a route search method, a known search method can be adopted. The route setting unit 122 uses the exercise information DB 200 of the storage unit 130 to set a walking section as necessary in the route from the current place to the destination. In this way, the route setting unit 122 sets a walking section together with the vehicle moving section as a movement route of the user U1 as necessary. A method of setting the walking section will be described in detail with reference to FIG. 4. The route setting unit 122 outputs information related to the extracted route candidates to the vehicle dispatch processing unit 121. The walking section is an example of an exercise section.

The vehicle dispatch processing unit 121 assigns an appropriate vehicle from the plurality of vehicles C1 to C3 based on the vehicle dispatch request. For example, the vehicle dispatch processing unit 121 uses the location information (location information indicating current places of the vehicles C1 to C3) transmitted from the communication devices 21 to 23 and the map DB of the storage unit 130 to assign an available vehicle that is closest to the boarding place of the vehicle moving section set by the route setting unit 122. The vehicle dispatch processing unit 121 uses the map DB of the storage unit 130 to set a movement route from a current place of the assigned vehicle to the boarding place, and transmits instruction information to the communication device of the vehicle so as to travel to the boarding place along the set movement route. The movement route of the vehicle set in this way is, for example, a route that takes the shortest time to reach the boarding place among routes from the current place of the assigned vehicle to the boarding place.

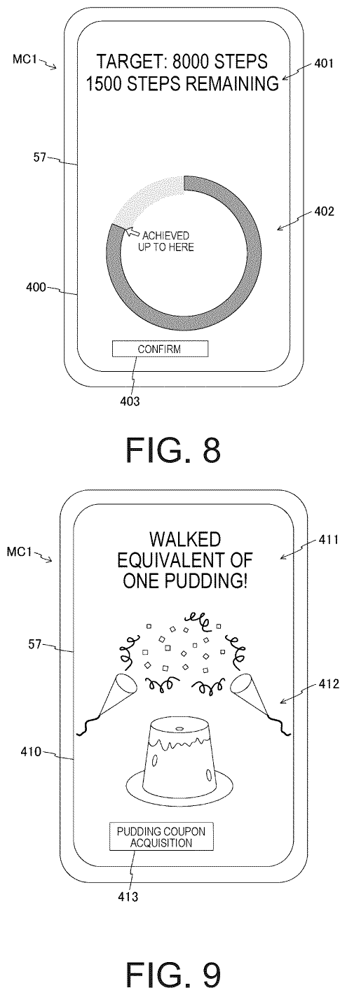

The exercise information management unit 123 manages exercise information of a user who uses the vehicle dispatch service. For example, when each piece of information related to exercise of the user U1 is transmitted from the electronic device MC1, the exercise information management unit 123 stores each piece of information related to the exercise in the exercise information DB 200 of the storage unit 130 in association with the user U1. The exercise information management unit 123 generates achievement information related to the walking section set by the route setting unit 122 using the exercise information DB 200. The achievement information will be described in detail with reference to FIGS. 8 to 11. The exercise information management unit 123 uses the exercise information DB 200 to determine an incentive to be given to the user whose walking section is set by the route setting unit 122. The incentive will be described in detail with reference to FIGS. 8 to 11.

The vehicle dispatch processing unit 121 transmits, to the electronic device MC1, assistance information including the fact that the vehicle dispatch reservation from the user U1 has been received and boarding or disembarking place information related to the set boarding or disembarking place. In addition, the vehicle dispatch processing unit 121 transmits the boarding place of the user U1, a walking time to the boarding place, and the like to the communication device of the assigned vehicle.

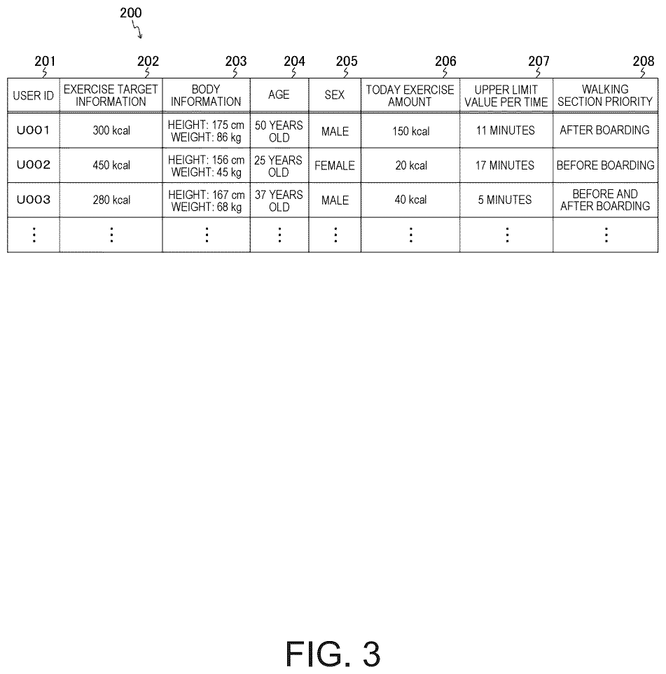

The storage unit 130 is a storage medium that stores various types of information. For example, the storage unit 130 stores various types of information (for example, a control program, an exercise information database (DB) 200 (see FIG. 3), a map DB, a customer DB, and a boarding or disembarking place DB) necessary for the control unit 120 to perform various types of processing. The storage unit 130 stores various types of information acquired via the communication unit 110. As the storage unit 130, for example, various storage medium such as a read only memory (ROM), a random access memory (RAM), a hard disk drive (HDD), and a solid state drive (SSD) can be used.

The map DB stores map information required for route setting such as road information and facility information. The map information includes a gradient of a road, an intersection point of the road, the number of lanes of the road, road width information, and undulation information of the road. The map information includes a road sign indicating a speed limit, one-way traffic, and the like, and a road marking indicating a crosswalk, a carriageway marking, and the like. In addition, the map information may include facility information such as road structures (for example, a traffic signal, a telephone pole), and buildings.

The customer DB stores account information of a user who uses the vehicle dispatch service of the information processing system 1, use history of the vehicles C1 to C3 of each user, an attribute of each user, and the like. The account information is, for example, a user ID.

The boarding or disembarking place DB is a database that stores boarding or disembarking place information related to a place (referred to as a boarding place) where the user who has made the vehicle dispatch reservation boards one of the vehicles C1 to C3 and a place (referred to as a disembarking place) where the user disembarks from one of the vehicle C1 to C3. The boarding or disembarking place information is information for specifying locations of the boarding place and the disembarking place, and is, for example, latitude and longitude. The boarding place and disembarking place are places where it is possible to board or disembark from a vehicle, and places are set where the vehicle can be parked and stopped among places on the road or adjacent to the road. That is, since the places where the vehicle can be parked and stopped are determined on the road, when the user is not present at a place where the vehicle can be parked and stopped, the user cannot board the vehicle assigned by the vehicle dispatch reservation. Therefore, in the present embodiment, the places where the vehicle can be parked and stopped on a road are set in advance as the boarding or disembarking place (the boarding place and the disembarking place), and the boarding or disembarking places are registered in advance in the boarding or disembarking place DB. A density of the boarding or disembarking places is appropriately set according to the road and a surrounding environment. In this way, the boarding place is a meeting place between the user who has made the vehicle dispatch reservation and the vehicle assigned by the vehicle dispatch reservation. The disembarking place is a place where the user who has made the vehicle dispatch reservation disembarks from the vehicle assigned by the vehicle dispatch reservation.

The boarding place and the disembarking place are set by the route setting unit 122. For example, when making the vehicle dispatch reservation using the vehicle dispatch application, the user U1 inputs a destination to which the user heads after boarding the vehicle. For example, a destination may be specified on a map displayed on an input and output unit 56 of the electronic device MC1, or a destination may be specified from a plurality of preset places (for example, tourist spots or facilities). A method of specifying the destination will be described in detail with reference to FIG. 5.

The exercise information DB 200 is a database that manages exercise information related to a user who uses the vehicle dispatch service of the management server 100. The exercise information DB 200 will be described in detail with reference to FIG. 3.

### Functional Configuration Example of Electronic Device

The electronic device MC1 includes a communication unit 51, a control unit 52, a storage unit 53, a location information acquisition unit 54, an acceleration sensor 55, an output unit 57, and an input unit 58. Each of the communication unit 51, the storage unit 53, the location information acquisition unit 54, the acceleration sensor 55, the output unit 57, and the input unit 58 may be built in the electronic device MC1 or may be configured as a separate body detachable from the electronic device MC1.

Under the control of the control unit 52, the communication unit 51 exchanges various types of information with other devices using one of wired communication or wireless communication. In the example shown in FIG. 1, the communication unit 51 communicates with the management server 100 via the network 10.

The control unit 52 controls each unit based on various programs stored in the storage unit 53. The control unit 52 is implemented by, for example, a processing device such as a CPU.

The storage unit 53 is a storage medium that stores various types of information. For example, the storage unit 53 stores various types of information (for example, the control program, the vehicle dispatch application, and the exercise information) necessary for the control unit 52 to perform various types of processing. The storage unit 53 stores various types of information acquired via the communication unit 51. As the storage unit 53, for example, various storage medium such as ROM, RAM, HDD, and SSD can be used.

The location information acquisition unit 54 acquires location information related to a location where the electronic device MC1 is present, and outputs the acquired location information to the control unit 52. The location information acquisition unit 54 can be implemented by, for example, a global navigation satellite system (GNSS) receiver that acquires location information using GNSS. The location information includes data related to the location such as latitude, longitude, altitude, and the like when a GNSS signal is received. In addition, the location information may be acquired by another location information acquisition method. For example, the location information may be derived using information from an access point or a base station existing in the periphery. In addition, for example, the location information may be derived using a location estimation technique by a navigation device. The location information of the electronic device MC1 acquired by the location information acquisition unit 54 may be transmitted to the management server 100 at any timing, or may be included in the vehicle dispatch request when the vehicle dispatch request is transmitted to the management server 100.

The acceleration sensor 55 is a sensor that detects an acceleration of the electronic device MC1, and outputs acceleration information related to the detected acceleration to the control unit 52. Based on the acceleration of the electronic device MC1 detected by the acceleration sensor 55, the state and movement of the electronic device MC1, such as an inclination and a moving speed can be grasped. Based on the acceleration of the electronic device MC1 detected by the acceleration sensor 55, an exercise amount of the user U1 carrying the electronic device MC1, for example, a step count, a moving speed, a moving distance, and the like can be measured.

The output unit 57 outputs various types of information under the control of the control unit 52. As the output unit 57, for example, a display panel such as an organic electro luminescence (EL) panel or a liquid crystal display (LCD) panel, or a sound output unit (for example, a speaker) that outputs various types of sound.

The input unit 58 receives an operation input for operating the electronic device MC1. For example, the input unit 58 may be various operation members (for example, a switch, a button), or a user interface such as a touch panel. The output unit 57 and the input unit 58 can be integrally configured using a user interface such as an input and output panel that allows a user to perform an operation input by touching or approaching a display surface with his/her finger. FIGS. 5 to 11 and 15 show an example in which the output unit 57 and the input unit 58 are integrally configured as the input and output unit 56.

Although the configuration examples of the communication devices 21 to 23 provided in the vehicles C1 to C3 are not shown in the drawings, the configurations of the communication devices 21 to 23 may be substantially the same as the configuration of the electronic device MC1. A communication unit of each of the communication devices 21 to 23 communicates with the management server 100 via the network 10. The location information on each of the vehicles C1 to C3 acquired by a location information acquisition unit of each of the communication devices 21 to 23 is transmitted to the management server 100 at a predetermined timing. The vehicles C1 to C3 include a vehicle electronic control unit (ECU). The vehicle ECU controls various actuators (for example, a brake actuator, an accelerator actuator, a steering actuator, and the like) based on the control information received from the management server 100.

### Example of Stored Contents of Exercise Information DB

FIG. 3 is a simplified diagram of stored contents of the exercise information DB 200 stored in the storage unit 130.

The exercise information DB 200 is a database that manages exercise information related to a user who uses the vehicle dispatch service of the management server 100. Specifically, exercise target information 202, body information 203, age 204, sex 205, a today exercise amount 206, an upper limit value 207 per time, and a walking section priority 208 are stored in the exercise information DB 200 in association with a user ID 201. It is assumed that “U001” of the user ID 201 corresponds to the user U1 (see FIG. 1). In addition, each piece of information shown in FIG. 3 is an example, only a part of the pieces of information may be stored in the exercise information DB 200, and other information may be stored in the exercise information DB 200.

The exercise target information 202 is information indicating an exercise target of the user. For example, numerical values indicating the exercise amount per day as a target of the user, for example, the target step count, a target distance, and target calories burned are stored as the exercise target information. The exercise target information may be set by a manual operation of the user or may be automatically set to general values based on various pieces of information on the user, for example, the body information 203, the age 204, and the sex 205. In this way, the present embodiment shows an example in which an exercise target value is set in advance.

The body information 203 is information related to a body of the user. For example, numerical values indicating a height and a weight of the user are stored as the body information. The body information can be set by the manual operation of the user.

The age 204 is the age of the user. The sex 205 is the sex of the user. Each piece of information can be registered in advance by the user who uses the vehicle dispatch service.

The today exercise amount 206 is information indicating an exercise amount actually performed by the user on the day, for example, exercise history. For example, numerical values indicating the exercise amount actually performed by the user on the day, for example, a step count, a distance, and calories burned are stored as the today exercise amount. For example, the electronic device MC1 carried by the user U1 can measure a step count of the user U1 and store the step count in the storage unit 53 in association with the time. Therefore, the electronic device MC1 transmits step count information (the step count and the time) stored in the storage unit 53 to the management server 100 periodically or irregularly, and thus the management server 100 can acquire the today exercise amount (the step count) of the user U1. The electronic device MC1 can store the location information acquired by the location information acquisition unit 54 and the acceleration information acquired by the acceleration sensor 55 in the storage unit 53 in association with the acquisition time. Therefore, the electronic device MC1 transmits the location information and the acceleration information stored in the storage unit 53 to the management server 100 periodically or irregularly, and thus the management server 100 can acquire movement history of the user U1. The exercise information management unit 123 can acquire the exercise amount actually performed by the user U1 on the day based on the movement history of the user U1. The today exercise amount may be set by the manual operation of the user.

The upper limit value 207 per time is information indicating an upper limit value of a walking section per one time that can be set for the user who uses the vehicle dispatch service. For example, numerical values indicating the exercise amount that the user can walk at a time, for example, walking time, a walking distance, a step count, and calories burned are stored as the upper limit value per time. The upper limit value per time may be set by the manual operation of the user, or may be automatically set based on various types of information related to the user, for example, the body information 203, the age 204, and the sex 205. The upper limit value per time may be automatically set based on use history of a past vehicle dispatch service of the user. For example, when an average walking time based on the use history of the past vehicle dispatch service is 10 minutes, the 10 minutes can be set as the upper limit value per time. In addition, for example, the upper limit value per time may be learned and estimated using artificial intelligence (AI).

The walking section priority 208 is information indicating a priority of a location of a walking section set for the user who uses the vehicle dispatch service. For example, since the walking section can be set front or after the vehicle moving section or both front and after the vehicle moving section, any one thereof can be set a walking section with a highest priority. The priority of the walking section will be described in detail with reference to FIG. 4.

### Setting Example of Walking Section

FIG. 4 is a simplified diagram illustrating a relationship between a vehicle moving section and a walking section set according to the vehicle dispatch reservation. (A) to (D) of FIG. 4 show examples in which the vehicle moving section and the walking section are set in a route from a departure place S1 to a destination G1 in order to facilitate the description. The vehicle moving section means a section in which the user moves while boarding a vehicle assigned by the vehicle dispatch service. The walking section means a section in which the user who uses the vehicle dispatch service walks, and is set before or after the vehicle moving section.

In addition, the departure place means a current place of the user who uses the vehicle dispatch service, a location in the vicinity of the current place, a boarding place related to a vehicle specified by the user who uses the vehicle dispatch service, and the like. In addition, the destination means a destination specified by the user who uses the vehicle dispatch service or a disembarking place near the destination. For the departure place, when the current place of the user is set as the departure place, a specification operation by the user becomes unnecessary. For example, in a case where a user boarding a train wants to board the vehicle from a next station, it is also possible to eliminate the specification operation by the user by estimating the station as the departure place. In a case where it is desired to quickly board the vehicle, it is also possible to execute the vehicle dispatch processing by notifying the management server 100 of only the current place of the user. In this case, the destination can be specified after the user board the dispatched vehicle.

FIG. 4(A) shows an example in which only a vehicle moving section VS1 is set in the route from the departure place S1 to the destination G1. FIG. 4(B) shows an example in which a vehicle moving section VS2 and a walking section WS2 on the departure place S1 side are set in the route from the departure place S1 to the destination G1. FIG. 4(C) shows an example in which a vehicle moving section VS3 and a walking section WS3 on the destination G1 side are set in the route from the departure place S1 to the destination G1. FIG. 4(D) also shows an example in which, a vehicle moving section VS4, a walking section WS4 on the departure place S1 side and a walking section WS5 on the destination G1 side are set in the route from the departure place S1 to the destination G1.

As shown in FIG. 4(A), in a case where only the vehicle moving section VS1 is set, it is also assumed that the departure place and the boarding place are different when the departure place is a place where the vehicle cannot be parked and stopped. Similarly, in the case where only the vehicle moving section VS1 is set, it is also assumed that the destination and the disembarking place are different when the destination is a place where the vehicle cannot be parked and stopped. However, as shown in FIG. 4(B), in a case where the walking section WS2 is set on the departure place S1 side, the departure place S1 and a start point of the walking section WS2 can be set at the same location. Similarly, as shown in FIG. 4(C), in a case where the walking section WS3 is set on the destination G1 side, the destination G1 and an end point of the walking section WS3 can be set at the same location. The same applies to the example shown in FIG. 4(D). However, in order to facilitate the description, it is assumed that the departure place S1 and the boarding place are the same, and the destination G1 and the disembarking place are the same.

As shown in (B) to (D) of FIG. 4, the walking sections WS2 to WS5 are set before and after the vehicle moving sections VS2 to VS4. A length of the walking section is set based on the upper limit value 207 per time of the exercise information DB 200. For example, for the user U1 for which “11 minutes” is stored in the upper limit value 207 per time, a distance that the user U1 can walk in 11 minutes is calculated, and a walking section within a range of the calculated distance is set. As a method of calculating the distance, the distance may be calculated based on a general walking speed, or may be calculated in consideration of age, sex, past walking history, and the like of the user U1.

As shown in FIG. 4(B), in the case where the walking section WS2 is set on the departure place S1 side, an end point of the walking section WS2 is the boarding place, and thus the end point of the walking section WS2 is set from boarding or disembarking place candidates. As shown in FIG. 4(C), in the case where the walking section WS3 is set on the destination G1 side, a start point of the walking section WS3 is the disembarking place, and thus the start point of the walking section WS3 is set from the boarding or disembarking place candidates. Similarly, in the example shown in FIG. 4(D), an end point of the walking section WS4 and a start point of the walking section WS5 are set from the boarding or disembarking place candidates.

A location of the walking section relative to the vehicle moving section can be appropriately set based on the priority, a road environment, a walking environment, weather information, and the like. For example, as shown in FIG. 3, the priority of the location of the walking section (walking section priority 208) can be set in advance based on user settings. For example, for a user who wants to walk after boarding the vehicle, a priority on a rear side of the vehicle moving section can be set to be high. For a user who wants to walk before boarding the vehicle, a priority on a front side of the vehicle moving section can be set to be high. For a user who wants to walk before and after boarding the vehicle, the priorities on the front and rear sides of the vehicle moving section can be set to be high. The location of the walking section is determined based on the set priority. In this way, the location of the walking section can be determined according to a preference of the user. However, for example, even in the case of the user for which the priority on the rear side of the vehicle moving section is set to be high, when a vicinity of the destination is a vehicle dedicated road, the walking section may be set before the vehicle moving section with a lower priority. In this way, by setting a walking condition according to the preference of the user in advance, it is possible to set a walking section according to the preference of the user.

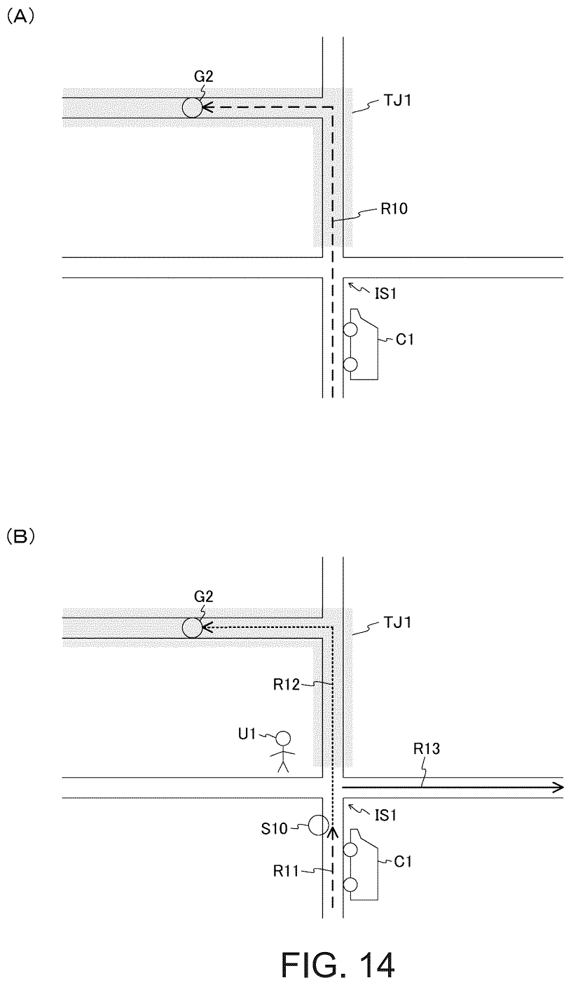

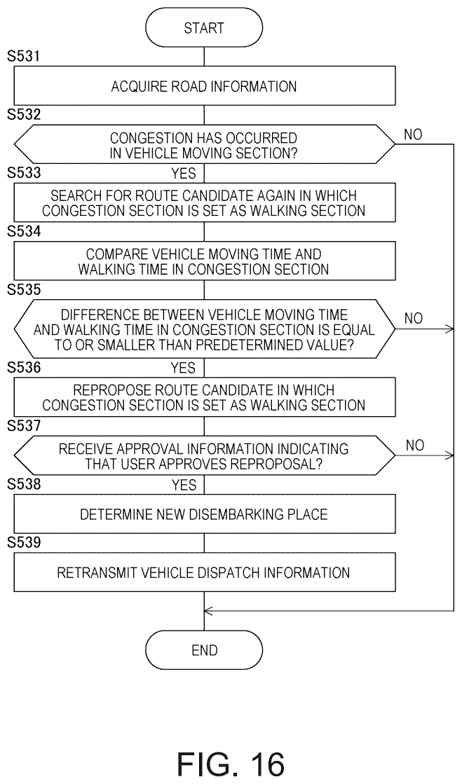

The location of the walking section may be set based on the road environment and the walking environment. For example, on the nature of a road, there are a road that is easy to walk, a road that is difficult to walk, a vehicle dedicated road, a pedestrian dedicated road, a road with a good view, and a road on which shopping is possible. Therefore, in the route from the departure place S1 to the destination G1, when there is a road that is easy to walk, a road with a good view, a road on which shopping is possible, or a pedestrian dedicated road, a section including at least a part of the roads can be determined as a walking section. On the other hand, in the route from the departure place S1 to the destination G1, when there is a road that is difficult to walk or a vehicle dedicated road, the walking section can be determined so that the roads are not included. The information related to the roads can be acquired from the map DB of the storage unit 130. The walking section may be set based on a road condition. For example, in a congestion section, it is faster to move by foot than by vehicle. Therefore, when there is a congestion section in the route from the departure place S1 to the destination G1, a section including at least a part of the congestion section can be determined as a walking section. In the congestion section in the road, congestion information of the road corresponding to a location of the road and a time can be acquired from another device, for example, a congestion information providing server via a predetermined network, for example, the Internet, based on the location and the time. A setting example of a walking section when a congestion occurs after boarding the vehicle will be described in detail with reference to FIGS. 14 and 16.

The location of the walking section may be set based on the road environment and the walking environment, for example, the weather around the road. For example, a walking period may be set so as to walk at a timing with good weather. For example, in the route from the departure place S1 to the destination G1, when the weather forecast predicts that it is sunny near the departure place S1 but it is raining near the destination G1, it is preferable to walk near the departure place S1. Therefore, in such a case, the walking section can be set before the vehicle moving section. On the other hand, in the route from the departure place S1 to the destination G1, when the weather forecast predicts that it is raining near the departure place S1 but it is sunny near the destination G1, it is preferable to walk near the destination G1. Therefore, in such a case, the walking section can be set after the vehicle moving section. Regarding the weather around the road, weather information corresponding to the location of the road and the time can be acquired from another device, for example, a weather information providing server via a predetermined network, for example, the Internet, based on the location and the time.

The location of the walking section may be set based on a physical condition of the user. For example, the walking period may be set so as to walk at a timing when the physical condition is good. For example, in a case where the user is tired for several reasons, it is preferable that the user first boards the vehicle to rest slowly and then walks. Therefore, in such a case, the walking section can be set after the vehicle moving section. On the other hand, in a case where the physical condition of the user is very good, it is also conceivable to board the vehicle after walking first, and to rest slowly. Therefore, in such a case, the walking section can be set before the vehicle moving section. The physical condition of the user can be acquired from an input by the manual operation of the user, or can be acquired from estimation by the electronic device MC1 or the like.

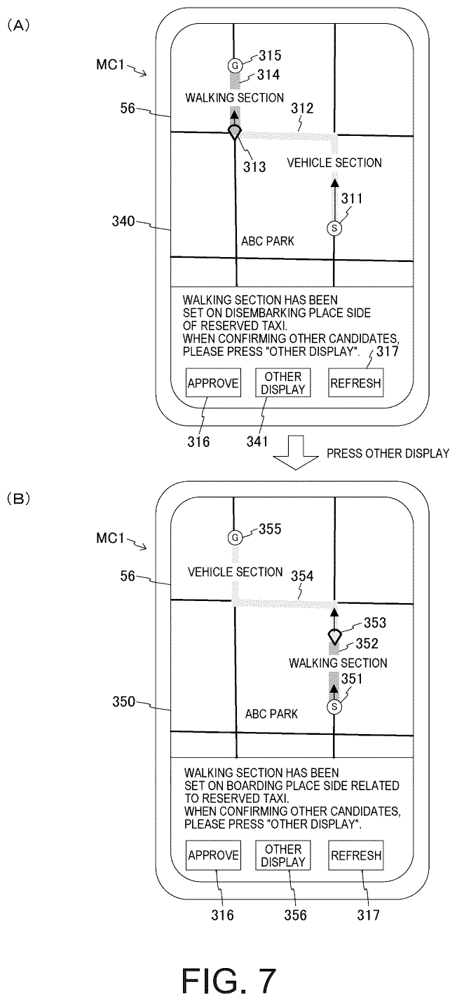

When a plurality of route candidates are extracted as the route from the departure place S1 to the destination G1, the vehicle moving section and the walking section are set for each of the route candidates. In this case, along with the plurality of route candidates, route information that can list the vehicle moving section and the walking section set for each route candidate may be provided to the user. Instead of the list display, the route information that can allow the user to view the vehicle moving section and the walking section in units of route candidates by a user operation may be provided to the user. The display example is shown in FIG. 7.

For example, it is assumed that a plurality of route candidates A to C are extracted as the route from the departure place S1 to the destination G1. In this case, a 10-minute walking section is set before the vehicle moving section in the route candidate A, a 10-minute walking section is set after the vehicle moving section in the route candidate B, and a 5-minute walking section is set before and after the vehicle moving section in the route candidate C. In this case, route information that can list the plurality of route candidates A to C and the vehicle moving section and the walking section of each of the route candidates A to C may be provided to the user, and route information that can allow the user to view the vehicle moving section and the walking section in units of route candidates by the user operation may be provided to the user.

For one route from the departure place S1 to the destination G1, one combination may be set as the vehicle moving section and the walking section, or a plurality of combinations may be set as the vehicle moving section and the walking section. Also in this case, route information that can list a plurality of combinations of the vehicle moving section and the walking section may be provided to the user along with the route from the departure place S1 to the destination G1.

For example, for the plurality of route candidates from the departure place S1 to the destination G1, one or a plurality of combinations of the vehicle moving section and the walking section may be provided to the user to allow the user to select one. For example, it is assumed that a plurality of route candidates A1 to E1 are extracted as the route from the departure place S1 to the destination G1. In this case, in a route candidate A1, a 10-minute walking section is set before and after the vehicle moving section. In a route candidate B1, a 5-minute walking section and a 15-minute walking section are respectively set before and after the vehicle moving section. In a route candidate C1, a 15-minute walking section and a 5-minute walking section are respectively set before and after the vehicle moving section. In a route candidate D1, a 20-minute walking section and a 0-minute walking section are respectively set before and after the vehicle moving section. In a route candidate E1, a 0-minute walking section and a 20-minute walking section are respectively set before and after the vehicle moving section. In this case, route information that can list the plurality of route candidates A1 to E1 and the vehicle moving section and the walking section of each of the route candidates A1 to E1, or route information that can be viewed in units of route candidates may be provided to the user, and a route candidate selected by the user operation may be determined.

In addition, for example, it is assumed that one combination is provided as the vehicle moving section and the walking section for a route candidate from the departure place S1 to the destination G1. In this case, when the user desires a route other than the route candidate, the user performs a user operation to request a search again. In response to the user operation, the management server 100 recalculates and provides other route candidates from the departure place S1 to the destination G1. For example, for the route candidate from the departure place S1 to the destination G1, it is assumed that a 10-minute walking section is set before and after the vehicle moving section and the route candidate is provided to the user. In this case, in a case where the user desires an 8-minute walking section before the vehicle moving section and a 12-minute walking section after the vehicle moving section, by performing a user operation to search again for other route candidates, the 8-minute walking section before the vehicle moving section and the 12-minute walking section after the vehicle moving section may be recalculated and provided as another route candidate from the departure place S1 to the destination G1.

### Display Example of Vehicle Dispatch Reservation Screen

FIG. 5 is a diagram illustrating a display example of a vehicle dispatch reservation screen 300 and an approval screen 310 displayed on the input and output unit 56 when the vehicle dispatch application is launched in the electronic device MC1. FIG. 5(A) shows a display example of the vehicle dispatch reservation screen 300 in which the user selects a destination from a plurality of preset places. For example, in a case of a vehicle dispatch service in which a finite number of stops are provided, a stop close to the destination is selected from the stops.

FIG. 5(A) shows the example in which the destination is selected from a plurality of places preset, but the user may select a desired destination on a map. In this case, a vehicle dispatch reservation screen including a map for selecting a destination is displayed on the input and output unit 56, and the user may select a desired destination on the map. The destination may be selected by another selection method.

FIG. 5(A) shows an example in which an “ABC castle” is selected as a destination. The present embodiment shows an example in which an arrival time at the destination is not specified, but the arrival time at the destination may be specified. In this case, the vehicle dispatch processing is executed based on the arrival time at the specified destination.

When the vehicle dispatch reservation is made using the vehicle dispatch application of the electronic device MC1, the user U1 launches the vehicle dispatch application of the electronic device MC1 and causes the input and output unit 56 to display the vehicle dispatch reservation screen 300. Next, the user U1 performs, on the vehicle dispatch reservation screen 300, a specification operation of specifying a destination to head by a vehicle assigned according to the vehicle dispatch reservation. Although not described here, the destination may be specified by a character search operation (for example, a keyword search of an address, a facility name, or the like).

When the vehicle dispatch reservation screen 300 is displayed, the user U1 performs a refinement operation of refining an area including the destination based on the character search or the map search. The vehicle dispatch reservation screen 300 is displayed, which includes in a list display region 301 a plurality of places that are preset in the area extracted by the refinement operation. Although an example is shown in which the list display region 301 is displayed by pressing a pull-down button 302, the pull-down button 302 may be omitted and only the list display region 301 may be displayed. In this example, the example is shown in which the refinement operation is performed using the character search or the map search, but the vehicle dispatch reservation screen 300 included in the list display region 301 may be displayed by other methods. For example, when the electronic device MC1 manages a schedule of the user U1, the control unit 52 of the electronic device MC1 can estimate the destination based on the schedule. For example, it is assumed that “ABC Castle with family from 11:00 on June 27” is recorded in the schedule. In this case, when the user U1 makes a vehicle dispatch reservation around 10:00 on June 27, the user U1 is likely to go to the ABC castle together with the family. Therefore, based on the schedule “ABC Castle with family from 11:00 on June 27”, it is possible to display the vehicle dispatch reservation screen 300 including the list display region 301 of an area (for example, city, town, and village) where the “ABC Castle” is located. The destination may be estimated and presented based on past history information of the user U1, or the destination may be estimated and presented by using artificial intelligence. In this example, the example is shown in which the destination is specified using the vehicle dispatch reservation screen 300, but the destination may be specified by a voice input or the like.

On the vehicle dispatch reservation screen 300, an exercise intention selection region 303 is displayed in which the user selects whether there is an intention to exercise before and after a boarding section (the vehicle moving section) related to the vehicle assigned according to the vehicle dispatch reservation. The user U1 performs a selection operation of selecting whether there is an intention to exercise before and after the vehicle moving section in the exercise intention selection region 303.

When the user U1 has an intention to exercise before and after the vehicle moving section, the user U1 selects a check box of “exercise intention (desire to set a walking section)”. On the other hand, when the user U1 has no intention to exercise before and after the vehicle moving section, the user U1 selects a check box of “no exercise intention (no desire to set a walking section)”. In a case where the user U1 wants to determine whether to exercise after viewing a walking section proposed by the management server 100, the user U1 selects a check box of “depending on a walking section”.

That is, when the destination is specified using the vehicle dispatch reservation screen 300, the user U1 performs a selection operation of selecting a destination desired by the user U1 from the plurality of places included in the list display region 301. After the selection operation, the user U1 presses a confirm button 304 after performing the selection operation in the exercise intention selection region 303. In this example, the example is shown in which the user selects the presence or absence of the exercise intention each time the vehicle dispatch service is used, but the user may preset the presence or absence of the exercise intention, and a setting content thereof may be reflected each time the vehicle dispatch service is used.

When the confirm button 304 is pressed after the specification operation of the destination and the exercise intention selection operation described above are performed, the control unit 52 of the electronic device MC1 transmits a vehicle dispatch request to the management server 100. The vehicle dispatch request includes the location information related to the current place of the user U1, the location information related to the destination, the exercise information related to the exercise intention, and the user ID. When a place other than the current place of the user U1 is set as a departure place, the user U1 performs a specification operation of specifying a departure place. In this case, location information related to the departure place is included in the vehicle dispatch request and transmitted. Instead of specifying the destination, a general area to head by vehicle may be specified. For example, in a case of going to Osaka from the current place of Tokyo, it is also assumed that Osaka is specified as the general area. In this case, the location information related to the general area is included in the vehicle dispatch request and transmitted.

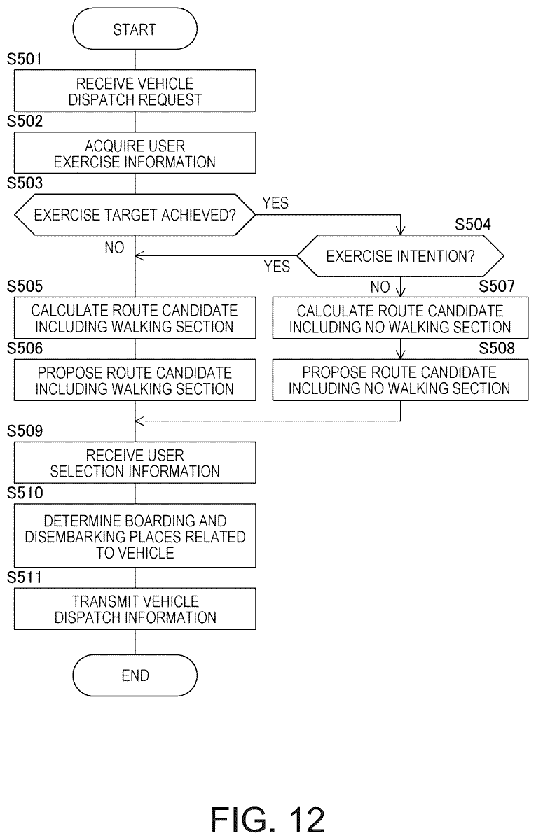

The management server 100 that has received the vehicle dispatch request executes setting processing of the walking section, setting processing of the boarding place and the disembarking place, and assignment processing of the vehicle. Each processing in the management server 100 when the vehicle dispatch request is received will be described in detail with reference to FIG. 12 and the like. The management server 100 transmits assistance information (riding assistance information and walking assistance information), which is a processing result, to the electronic device MC1. A display example of the input and output unit 56 after the assistance information is received is shown in FIG. 5(B). The display example shown in FIG. 5(B) is a display example when the “exercise intention (desire to set a walking section)” is selected in the exercise intention selection region 303 shown in FIG. 5(A).

### Display Example of Approval Screen

FIG. 5(B) shows a display example of the approval screen 310 displayed on the input and output unit 56 after a reservation operation is performed using the vehicle dispatch application in the electronic device MC1. Specifically, the approval screen 310 is shown in which the vehicle moving section and the walking section set by the user U1 are displayed in response to the reservation operation.

As shown in FIG. 5(B), the control unit 52 of the electronic device MC1 displays the approval screen 310 for assisting boarding and walking of the user U1 on the input and output unit 56 based on the assistance information transmitted from the management server 100.

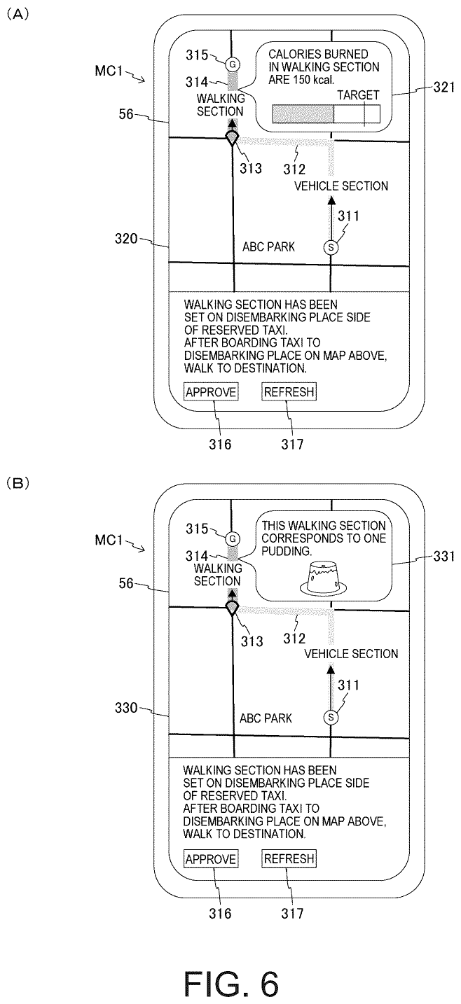

On the approval screen 310, a boarding place marker 311 indicating a boarding place, a disembarking place marker 313 indicating a disembarking place, and a vehicle moving section marker 312 indicating a vehicle moving section from the boarding place to the disembarking place are displayed. Further, on the approval screen 310, a destination marker 315 indicating a destination and a walking section marker 314 indicating a walking section from the disembarking place to the destination are displayed. The vehicle moving section marker 312 and the walking section marker 314 are movement routes of the user set by the vehicle dispatch reservation. For example, the vehicle moving section marker 312 and the walking section marker 314 can be highlighted with thick bands on the map. In this case, it is preferable to display the vehicle moving section marker 312 and the walking section marker 314 preferably in different modalities, for example, different colors. For example, the vehicle moving section marker 312 may be displayed in yellow, and the walking section marker 314 may be displayed in green. In addition, it is preferable to display a characteristic marker, for example, a marker in which a pin is stuck (the disembarking place marker 313 in FIG. 5(B)) at a transition point of the vehicle moving section and the walking section. A vehicle moving time may be displayed near the vehicle moving section marker 312, and a walking time may be displayed near the walking section marker 314. In addition, information related to the exercise amount of the user may be displayed near the walking section marker 314. FIG. 6 shows a display example of the information related to the exercise amount of the user.

In a lower display region of the approval screen 310, an approval button 316 for approving a route candidate displayed on the approval screen 310 and a refresh button 317 for requesting a route other than the route candidate displayed on the approval screen 310 to be searched again are displayed.

When the approval button 316 is pressed, a movement assistance screen for assisting the movement of the user U1 toward the destination is sequentially displayed according to the route candidate shown on the approval screen 310. For example, as in a known navigation system, guidance for walking along the walking section may be displayed as the movement assistance screen. Based on the information from the management server 100, the control unit 52 of the electronic device MC1 can sequentially display latest information on a scheduled arrival time of the vehicle, a waiting time at the boarding place, a scheduled arrival time of the destination, and the like. Further, the control unit 52 of the electronic device MC1 may perform the guidance by a voice output.

FIG. 5(B) shows the example in which the map is displayed on the approval screen 310 to notify the user U1 of the boarding or disembarking place, the vehicle moving section, and the walking section, but the movement assistance may be performed by displaying a three-dimensional image or an image using augmented reality (AR) on the electronic device MC1. In addition, the movement assistance may be performed by outputting voice information and notifying the user of each piece of information.

When the refresh button 317 is pressed, a route candidate other than the route candidate shown on the approval screen 310 is recalculated by the management server 100. In this case, a new route candidate obtained by refreshing is displayed on the approval screen 310.

FIG. 5(B) shows an example in which the walking section is set after the vehicle moving section, but the same can be applied to the case in which the walking section is set before the vehicle moving section. This display example is shown in FIG. 7(B). FIG. 5(B) shows an example in which one route candidate is displayed on the same map, but a plurality of route candidates may be displayed on the same map, or a plurality of route candidates may be displayed on separate screens. FIG. 7 shows an example of displaying a plurality of route candidates on separate screens. For example, when three route candidates are displayed on the same map, identification information, for example, numbers 1 to 3 can be displayed near three route candidates, and a list (for example, numbers 1 to 3) of route candidates can be displayed in a region adjacent to the map. The user performs a selection operation of selecting a number of a desired route candidate in the list of route candidates.

### Display Example of Exercise Information

FIG. 6 is a diagram illustrating a display example in which information related to the exercise amount of the user is displayed on approval screens 320 and 330. Since the approval screens 320 and 330 are obtained by changing a part of the approval screen 310 shown in FIG. 5(B), the same parts as those in the approval screen 310 are denoted by the same reference numerals and the description thereof is omitted.

FIG. 6(A) shows an example in which as the information related to the exercise amount of the user, calories burned in the walking section are displayed numerically, and a relationship between the today exercise amount and the exercise target value is displayed in a bar display, for example a progress bar. The bar display is, for example, a display indicating a degree of achievement and a progress towards the exercise target value when the user walks through a walking section corresponding to the walking section marker 314. Each piece of information is displayed in a callout region 321 provided near the walking section marker 314. The exercise target value can be acquired based on the exercise target information 202 (see FIG. 3). In this example, the example is shown in which the information related to the exercise amount of the user may be displayed based on the calories burned in the walking section, but the information related to the exercise amount of the user may be displayed based on a distance of the walking section, a walking time, and the like.

FIG. 6(B) shows an example in which an image of food and drink corresponding to the calories burned in the walking section are displayed as the information related to the exercise amount of the user. The information is displayed in a callout region 331 provided near the walking section marker 314. A relationship between the food and drink and the calories burned can be acquired by presetting in the storage unit 130. In this example, the example is shown in which a pudding is used as an example of the food and drink corresponding to the calories burned in the walking section, but other food and drink may be displayed. In this way, by displaying the image of the food and drink corresponding to the calories burned in the walking section, the user U1 can easily grasp how much exercise amount is when walking through the walking section. The achievement information displayed in the callout regions 321 and 331 is generated by the exercise information management unit 123.

Although (A) and (B) of FIG. 6 show the example in which the information related to the exercise amount of the user is displayed in the callout regions 321 and 331 on the map, the information related to the exercise amount of the user may be displayed in other display modes. For example, a display region for displaying the information related to the exercise amount of the user may be provided in a lower region of the map. When the walking section on the map is tapped, the information related to the exercise amount of the user corresponding to the walking section may be displayed.

In addition, when a plurality of route candidates are displayed, the information related to the exercise amount of the user may be displayed for each route candidate. For example, a pudding may be displayed in a walking section in a route candidate A2, and a cake may be displayed in a walking section in a route candidate B2. In this case, since the information can be displayed in an intuitive and easy-to-understand manner, such as the pudding or cake, and the information can be referenced by the user when selecting a route candidate.

### Display Example of a Plurality of Route Candidates

FIG. 7 is a diagram illustrating a display transition example in which a plurality of route candidates are displayed on a plurality of screens. Since approval screens 340 and 350 are obtained by changing a part of the approval screen 310 shown in FIG. 5(B), the same parts as those in the approval screen 310 are denoted by the same reference numerals and the description thereof is omitted.

FIG. 7(A) shows a display example of the approval screen 340. The approval screen 340 is similar to the approval screen 310 except that an other display button 341 is provided. After confirming a route candidate displayed on the approval screen 340, the user U1 performs a pressing operation of pressing the other display button 341 when the user U1 wants to confirm other route candidates. FIG. 7(B) shows a display example after the other display button 341 is pressed.

FIG. 7(B) shows a display example of the approval screen 350. The approval screen 350 is a display example when a walking section is set before the vehicle moving section. Specifically, on the approval screen 350, a boarding place marker 353 indicating a boarding place, a disembarking place marker 355 indicating a disembarking place, and a vehicle moving section marker 354 indicating a vehicle moving section from the boarding place to the disembarking place are displayed. Further, on the approval screen 350, a departure place marker 351 indicating a departure place and a walking section marker 352 indicating a walking section from the departure place to the boarding place are displayed. In addition, an other display button 356 is displayed on the approval screen 350. After confirming a route candidate displayed on the approval screen 350, the user U1 performs a pressing operation of pressing the other display button 356 when the user U1 wants to further confirm other route candidates.

### Feedback Example of Walking Achievement in Walking Section

FIGS. 8 to 11 are diagrams illustrating a display example of achievement information displayed when the user who has used the vehicle dispatch service walks through the walking section. That is, FIGS. 8 to 11 show a notification example for notifying the user of an achievement status of the exercise target when the user who has used the vehicle dispatch service walks through the walking section. FIGS. 8 to 11 show an example in which an intuitive display format that is easy for the user to understand is adopted. This is displayed on the input and output unit 56 of the electronic device MC1 based on achievement information generated by the exercise information management unit 123.

FIG. 8 shows a display screen 400 on which the relationship between the exercise target value and the today exercise amount is displayed numerically and in a table. On the display screen 400, a first display region 401 and a second display region 402 are displayed. In the first display region 401, the relationship between the exercise target value and the today exercise amount is displayed numerically. For example, “Target: 8000 steps” is displayed as the exercise target value, and “1500 steps remaining” is displayed as a difference value between the exercise target value and the today exercise amount.

In the second display region 402, the relationship between the exercise target value and the today exercise amount is displayed in a pie chart. The exercise target value can be acquired based on the exercise target information 202 of the exercise information DB 200 (see FIG. 3). The today exercise amount can be acquired based on the today exercise amount 206 of the exercise information DB 200 (see FIG. 3).

In this way, after the user who has used the vehicle dispatch reservation walks through the walking section, an achievement rate of the exercise target can be easily grasped by viewing the display screen 400.

FIG. 8 shows the example in which the numerical value of the step count or the like is displayed as information related to the walking section, but other information related to the walking section, such as calories burned in the walking section, the distance of the walking section, and the walking time in the walking section, may also be displayed.

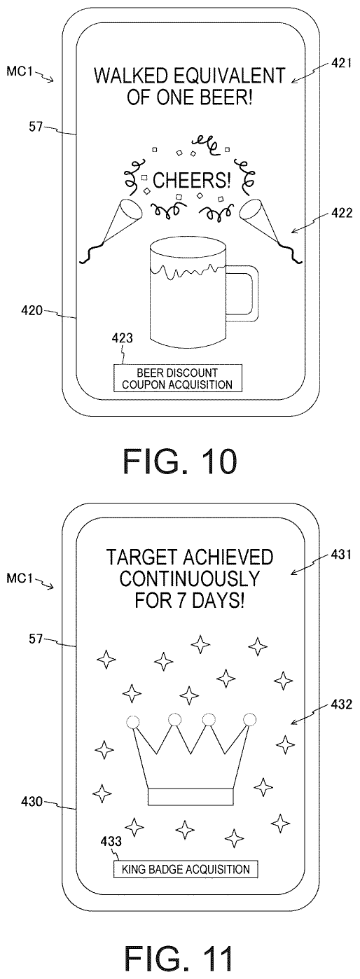

FIGS. 9 and 10 show display screens 410 and 420 on which the calories burned in the walking section are displayed with food and drink. On the display screen 410 shown in FIG. 9, a message region 411 showing the calories burned in the walking section by the number of puddings and an image display region 412 for displaying an image of a pudding are displayed. Further, a pudding coupon acquisition button 413 is provided on the display screen 410, and any incentive related to the pudding corresponding to the calories burned in the walking section may be acquired.

Here, the incentive shown in the present embodiment is given based on, for example, a numerical value related to the exercise amount. The incentive is, for example, an incentive related to the vehicle dispatch service, an incentive to make the vehicle dispatch service more profitable, and an incentive to make the vehicle dispatch service easy to use. In a specific example, a coupon, a point, a discount ticket, a discount point, a discount coupon, a point that can be converted into money, or the like can be an incentive. For example, when walking movement around a station is promoted, the number of visits to stores around the station increases, and thus coupons that can be used in the stores may be distributed as an incentive. In this way, both the incentive related to the vehicle dispatch service and the incentive that can be used in stores around the place where the user disembarks from the vehicle may also be given. That is, the incentive related to the vehicle dispatch service, the incentive usable at the disembarking place related to the vehicle, and the like may be given.

On a display screen 420 shown in FIG. 10, a message region 421 showing the calories burned in the walking section by the quantity of beers and an image display region 422 for displaying an image of the beer are displayed. Further, a beer discount coupon acquisition button 423 is provided on the display screen 420, and any incentive related to the beer corresponding to the calories burned in the walking section may be acquired.

As shown in FIGS. 8 to 10, after the user who has used the vehicle dispatch service walks through the walking section (or even while walking), a result of a walking exercise amount can be fed back to the user. That is, it is possible to display contents that the user who has used the vehicle dispatch service has achieved by walking in the walking section.

FIG. 11 shows a display example in which the vehicle dispatch service is used over a plurality of days. For example, a display screen 430 that is displayed when a user who does not perform daily exercise sets a walking section and achieves an exercise target continuously for 7 days is shown. In this way, the achievement status of the exercise status in a certain period may be displayed instead of the achievement status of the exercise status every one time.

On the display screen 430 shown in FIG. 11, a message region 431 indicating that the exercise target has been achieved for continuously 7 days and an image display region 432 for displaying an image of the achievement are displayed. Further, on the display screen 430, a king badge acquisition button 433 is provided, and some incentives related to the achievement of the exercise target continuously for 7 days may be acquired. For example, a badge indicating that the exercise target has been achieved continuously for 7 days may be acquired. For example, it is possible to store a setting state of the walking section and information related to walking in the walking section (for example, step count, the walking distance, and the calories burned) as walking history information in the exercise information DB 200 on a daily basis. The exercise information management unit 123 can confirm a date when the exercise target has been achieved based on the walking history information, and thus the achievement information can be generated based on the confirmation result. Accordingly, it is possible to improve motivation and satisfaction of the user who uses the vehicle dispatch service. In this way, the exercise information management unit 123 can give an incentive to the user U1 based on the exercise amount of the user U1 assumed by walking in the walking section.

### Operation Example of Vehicle Dispatch Processing

FIG. 12 is a flowchart showing an example of the vehicle dispatch processing in the management server 100. The vehicle dispatch processing is executed based on a program stored in the storage unit 130. The vehicle dispatch processing is executed when a vehicle dispatch request is received from the electronic device MC1. The vehicle dispatch processing will be described with reference to FIGS. 1 to 11 as appropriate.

In step S501, the vehicle dispatch processing unit 121 executes reception processing of receiving a vehicle dispatch request transmitted from the electronic device MC1 via the communication unit 110. For example, the vehicle dispatch request is transmitted from the electronic device MC1 based on a user operation using the vehicle dispatch reservation screen 300 shown in FIG. 5(A). The vehicle dispatch request includes location information related to a current place of the user U1, location information related to a destination, exercise intention information related to an exercise intention, and a user ID.

In step S502, the exercise information management unit 123 acquires exercise information corresponding to the user ID included in the vehicle dispatch request received in step S501 from the exercise information DB 200. In this example, the exercise information of each user is managed in the exercise information DB 200 of the management server 100, but the exercise information managed in the electronic device MC1 may be acquired. In this case, the exercise information may be included in the vehicle dispatch request.

In step S503, based on the exercise information acquired in step S502, the exercise information management unit 123 determines whether the user U1 corresponding to the user ID included in the vehicle dispatch request received in step S501 achieves an exercise target. For example, when a value of the today exercise amount 206 (see FIG. 3) is equal to or larger than a value of the exercise target information 202 (see FIG. 3), the exercise information management unit 123 determines that the exercise target is achieved. When the user U1 achieves the exercise target, the processing proceeds to step S504. On the other hand, when the user U1 does not achieve the exercise target, the processing proceeds to step S505.

In step S504, the exercise information management unit 123 determines whether the user U1 corresponding to the user ID included in the vehicle dispatch request received in step S501 has an intention to exercise based on the exercise intention information included in the vehicle dispatch request received in step S501. For example, when “exercise intention (desire to set a walking section)” or “depending on a walking section” is selected in the exercise intention selection region 303 of the vehicle dispatch reservation screen 300 shown in FIG. 5(A), it is determined that the user U1 has an intention to exercise. When the user U1 has an exercise intention, the processing proceeds to step S505. On the other hand, when the user U1 has no exercise intention, the processing proceeds to step S507.

In step S505, the route setting unit 122 searches for a route of a vehicle to be arranged for the user U1 corresponding to the user ID included in the vehicle dispatch request received in step S501, based on the location information related to the current place and the destination included in the vehicle dispatch request received in step S501. In this case, as shown in (B) to (D) of FIG. 4, the route setting unit 122 sets a walking section before and after the vehicle moving section. For a user who is determined in step S503 to have not achieved the exercise target, the processing of step S505 is executed regardless of the presence or absence of the exercise intention. Therefore, for the user who is determined in step S503 to have not achieved the exercise target, a route candidate not including a walking section may be searched together with a route candidate including a walking section, and each route candidate may be proposed.

In step S506, the vehicle dispatch processing unit 121 transmits route information including the route candidate (including boarding or disembarking place candidates) searched in step S505 to the electronic device MC1 that has transmitted the vehicle dispatch request received in step S501. That is, the vehicle dispatch processing unit 121 transmits the route information including the route candidate searched for in step S505 to the electronic device MC1 and displays the route candidate on the electronic device MC1, thereby proposing the route candidate to the user U1. For example, as shown in FIG. 5(B), the approval screen 310 including a route candidate in which a walking section is set after the vehicle moving section is displayed on the input and output unit 56 of the electronic device MC1.

In step S507, the route setting unit 122 searches for a route of a vehicle to be arranged for the user U1 corresponding to the user ID included in the vehicle dispatch request received in step S501, based on the location information related to the current place and the destination included in the vehicle dispatch request received in step S501. In this case, as shown in FIG. 4(A), the route setting unit 122 searches for a route candidate in which a walking section is not set.

In step S508, the vehicle dispatch processing unit 121 transmits route information including the route candidate (including boarding or disembarking place candidates) searched for in step S507 to the electronic device MC1 that has transmitted the vehicle dispatch request received in step S501. That is, the vehicle dispatch processing unit 121 transmits the route candidate searched for in step S507 to the electronic device MC1 and displays the route candidate on the electronic device MC1, thereby proposing the route candidate to the user U1.

As described above, the route candidates transmitted to the electronic device MC1 in step S506 or S508 are displayed on the input and output unit 56 of the electronic device MC1. The user U1 performs a selection operation of selecting a desired route from the route candidates displayed on the input and output unit 56 of the electronic device MC1. When the selection operation is performed, the control unit 52 of the electronic device MC1 transmits selection information including the route candidate selected by the selection operation to the management server 100. When only one route candidate is displayed on the input and output unit 56 of the electronic device MC1, approval information for approving the route candidate is transmitted to the management server 100.

In step S509, the vehicle dispatch processing unit 121 executes reception processing of receiving selection information (or approval information) from the electronic device MC1 that has transmitted the route information in step S506 or S508 via the communication unit 110. When the selection information is not received within a predetermined time after the route information is transmitted in step S506 or S508, the route information may be retransmitted or predetermined information for displaying a message for prompting transmission of the selection information may be transmitted.

In step S510, the vehicle dispatch processing unit 121 determines a boarding or disembarking place related to the vehicle in response to the vehicle dispatch request received in step S501 based on the selection information received in step S509. That is, the vehicle dispatch processing unit 121 determines a route selected by the user among the route candidates as a route of the vehicle in response to the vehicle dispatch request, and determines a boarding or disembarking place of the vehicle corresponding to the route.

In step S511, the vehicle dispatch processing unit 121 transmits the vehicle dispatch information including the boarding or disembarking place determined in step S510 to the electronic device MC1 that has transmitted the vehicle dispatch request received in step S501. The vehicle dispatch processing unit 121 transmits the vehicle dispatch information including the boarding or disembarking place determined in step S510 to the communication device of the vehicle. In this way, the processing of arranging a vehicle is executed in response to the vehicle dispatch request received in step S501.

### Operation Example of Achievement Information Output Processing

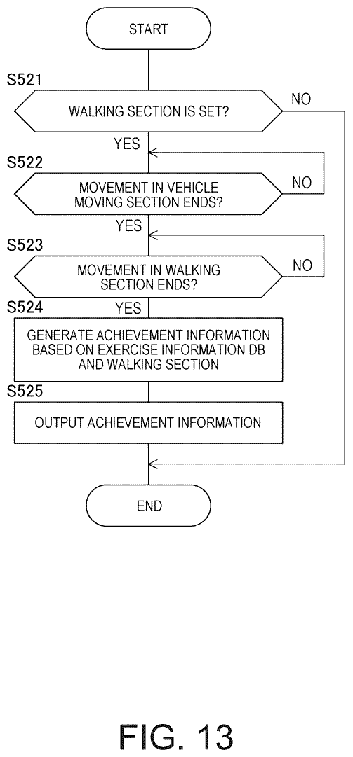

FIG. 13 is a flowchart showing an example of achievement information output processing in the management server 100. The achievement information output processing is executed based on a program stored in the storage unit 130. The achievement information output processing is executed for the user for whom the vehicle is arranged by the vehicle dispatch processing shown in FIG. 12. The achievement information output processing will be described with reference to FIGS. 1 to 12 as appropriate.

In step S521, the vehicle dispatch processing unit 121 determines whether a walking section is set for the user for whom the vehicle is arranged in step S511 (see FIG. 12). When the walking section is set, the processing proceeds to step S522. On the other hand, when the walking section is not set, the operation of the achievement information output processing ends.

In step S522, the vehicle dispatch processing unit 121 determines whether the movement in a vehicle moving section of the vehicle arranged in step S511 (see FIG. 12) ends. Whether the movement in the vehicle moving section ends can be determined based on location information of the vehicle acquired by a location information acquisition unit of a communication device installed in the vehicle. When location information of the user U1 acquired by the location information acquisition unit 54 of the electronic device MC1 can be acquired, whether the movement in the vehicle moving section ends can be determined based on the location information. When the movement in the vehicle moving section ends, the processing proceeds to step S523. On the other hand, when the movement in the vehicle moving section does not end, monitoring is continuously performed until the movement in the vehicle moving section ends.

In step S523, the vehicle dispatch processing unit 121 determines whether the movement in the walking section of the user for whom the vehicle is arranged in step S511 (see FIG. 12) ends. When the location information of the user U1 acquired by the location information acquisition unit 54 of the electronic device MC1 can be acquired, whether the movement in the walking section ends can be determined based on the location information. When the movement in the walking section ends, the processing proceeds to step S524. On the other hand, when the movement in the walking section does not end, the monitoring is continuously performed until the movement in the walking section ends.

In step S524, the exercise information management unit 123 generates achievement information based on the walking section of the user for whom the vehicle is arranged in step S511 (see FIG. 12) and the exercise information (exercise information DB 200) of the user.

In step S525, the vehicle dispatch processing unit 121 transmits the achievement information generated in step S524 to the electronic device MC1. The electronic device MC1 that has received the achievement information outputs the achievement information from the input and output unit 56. For example, the display screens 400, 410, 420, and 430 shown in FIGS. 8 to 11 are displayed on the input and output unit 56 of the electronic device MC1. The message corresponding to each display screen may be output by voice.

Here, due to the spread of convenient mobility services, the movement by walking of the user himself/herself is reduced, a lack of exercise may have an adverse effect on health. As described above, when the adverse effect on health occurs, the rich life of people may be threatened. For example, it is believed that many working people miss out on opportunities for daily exercise due to lack of time. That is, many people are aware of their lack of exercise and understand the importance of moderate exercise, but they often fail to take action due to a lack of time or because they find it troublesome.

Therefore, in the present embodiment, an appropriate exercise amount is secured while using a convenient vehicle dispatch service for daily movement. That is, it is possible to set a walking section before boarding or after disembarking from the vehicle arranged by the vehicle dispatch service to practice appropriate exercise by walking in the walking section, and to maintain health. In this way, by actively incorporating walking into the route from the departure place to the destination rather than relying solely on the vehicle, it is possible to achieve both the convenience of transportation and the health of the user. Accordingly, along with the richness that the mobility services bring, it is possible to realize the richness of the user himself/herself. In addition, by actively incorporating walking into the movement of the user, in addition to promoting health through exercise, the user can relax and change his/her mood.

### Example of Setting Walking Section After Making Vehicle Dispatch Reservation

In the above, the example is shown in which the walking section is set at the time of the vehicle dispatch reservation. That is, the example of determining whether to set a walking section based on the viewpoint of health of the user has been described. Here, it is also assumed that congestion occurs in the vehicle moving section while the vehicle assigned according to the vehicle dispatch reservation is traveling toward the disembarking place. In such a case, it is assumed that walking through the congestion section can be faster than moving by vehicle. Therefore, hereinafter, an example is shown in which a new walking section is set when the congestion occurs in the vehicle moving section. That is, an example of determining whether to set a walking section based on the viewpoint of a congestion degree of the vehicle is shown.

FIG. 14 is a diagram illustrating a transition example when a setting content at the time of vehicle dispatch reservation is changed based on the congestion information. FIG. 14 shows an example in which, at the time of vehicle dispatch reservation, a walking section is set before the vehicle moving section, that is, on the boarding place side or no walking section is set. FIG. 14 shows an example in which congestion occurs near an end point (disembarking place G2) of the vehicle moving section set at the time of vehicle dispatch reservation.

In FIG. 14(A), a route R10 of the vehicle moving section set at the time of the vehicle dispatch reservation is indicated by a dotted arrow. A section (congestion section TJ1) in which congestion occurs on a road is shown in gray. That is, FIG. 14(A) shows a state in which congestion has occurred near the end point (disembarking place G2) of the vehicle moving section set at the time of the vehicle dispatch reservation. For example, a state is shown in which congestion occurs from the vicinity of an intersection IS1. In the congestion section in the road, congestion information of the road corresponding to a location of the road and a time can be acquired from another device, for example, a congestion information providing server via a predetermined network, for example, the Internet, based on the location and the time.

As shown in FIG. 14(A), when the congestion occurs near the end point (disembarking place G2) of the vehicle moving section, there is a high possibility that the assigned vehicle stops for a long time or moves at a low speed until the vehicle travels toward the disembarking place G2, and there is a possibility that the moving time by vehicle becomes long. In this case, the time when the user U1 arrives at the destination may be delayed. In addition, there is also a possibility that the dispatched vehicle cannot proceed to the next transport service.

Therefore, when the congestion occurs near the disembarking place G2, the user U1 may walk from the vicinity of the disembarking place G2 to avoid the congestion. In addition, the dispatched vehicle can quickly proceed to the next transport service. Therefore, when the congestion occurs near the disembarking place G2, a new walking section is set and the user U1 is proposed to walk to the disembarking place G2. A method of setting a new walking section will be described in detail with reference to FIG. 16.

For example, as shown in FIG. 14(B), the end point (disembarking place S10) of the vehicle moving section is changed to a point just before the congestion section TJ1, and a walking section R12 is set in the congestion section TJ1. Accordingly, the vehicle from which the user U1 disembarks at the disembarking place S10 can avoid the congestion section TJ1 as indicated by an arrow R13 and quickly proceed to the next transport service.

### Display Example of Walking Section Setting Screen

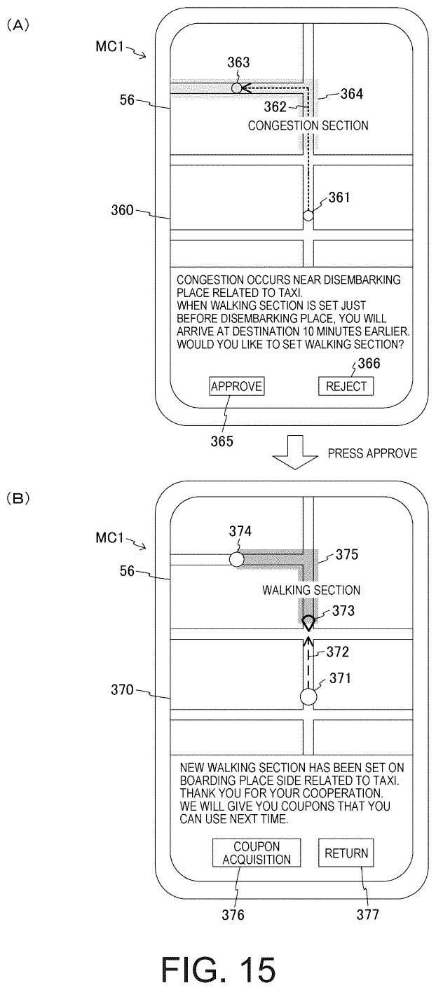

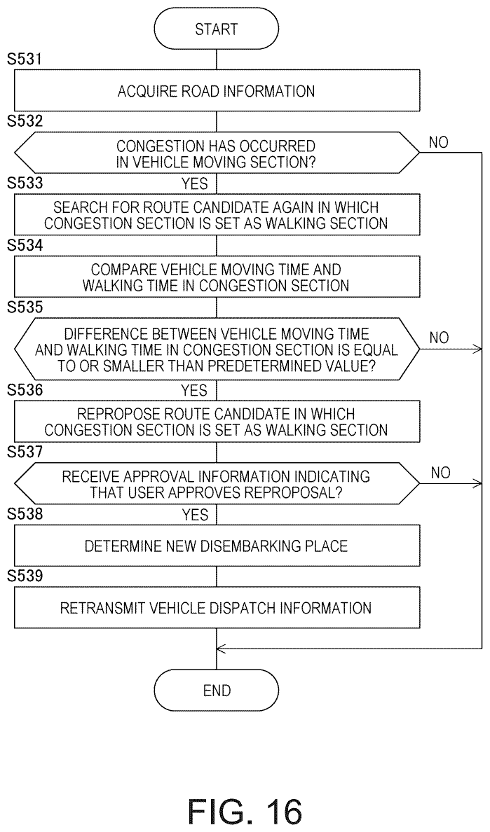

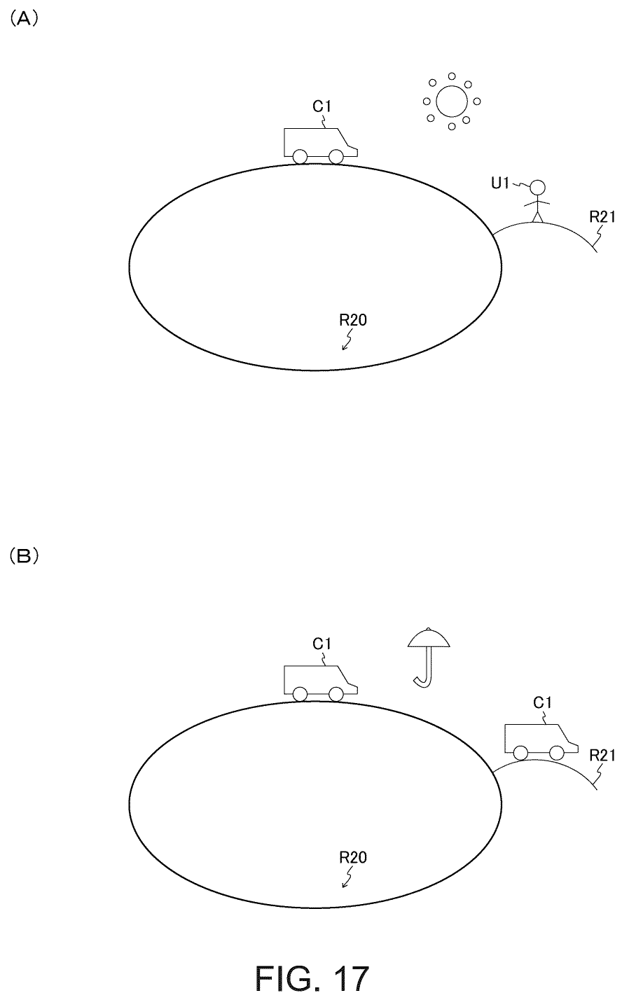

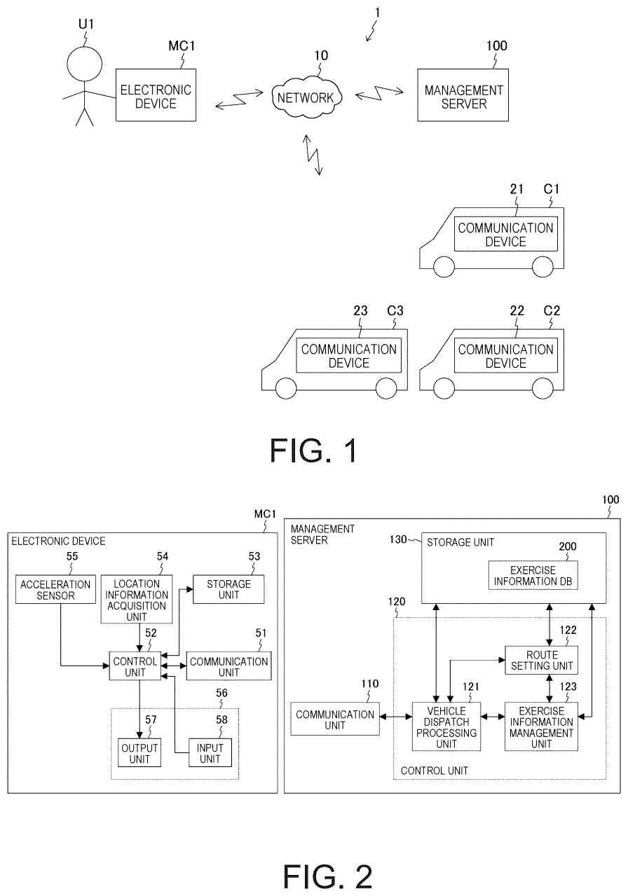

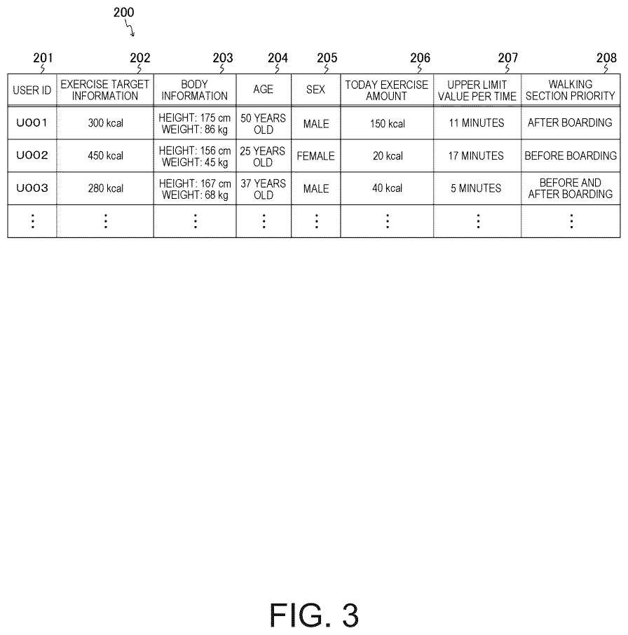

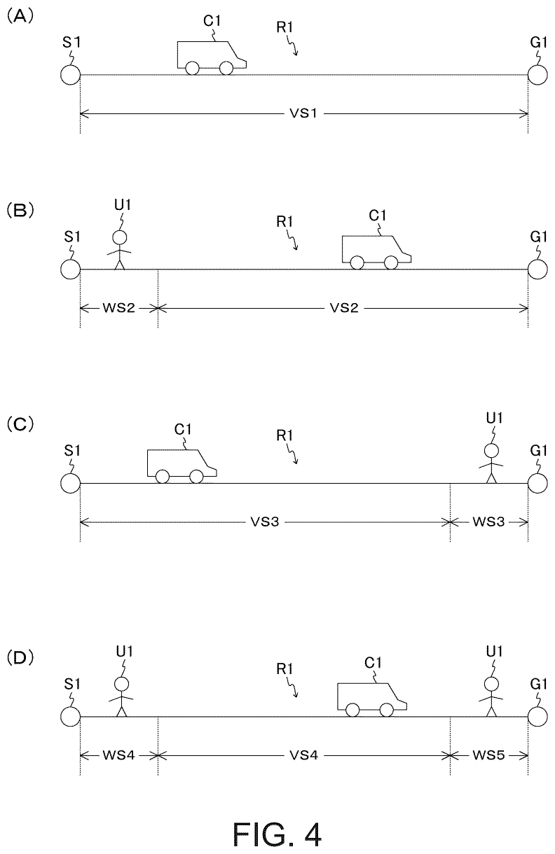

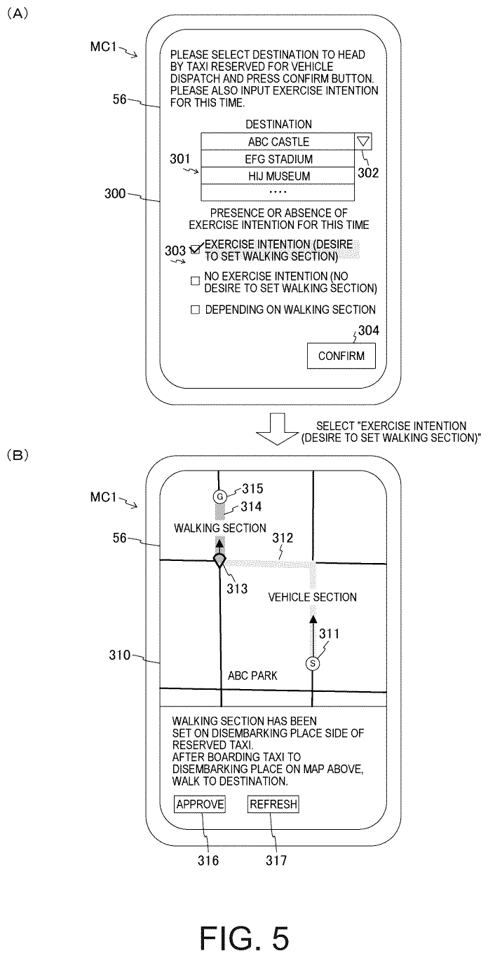

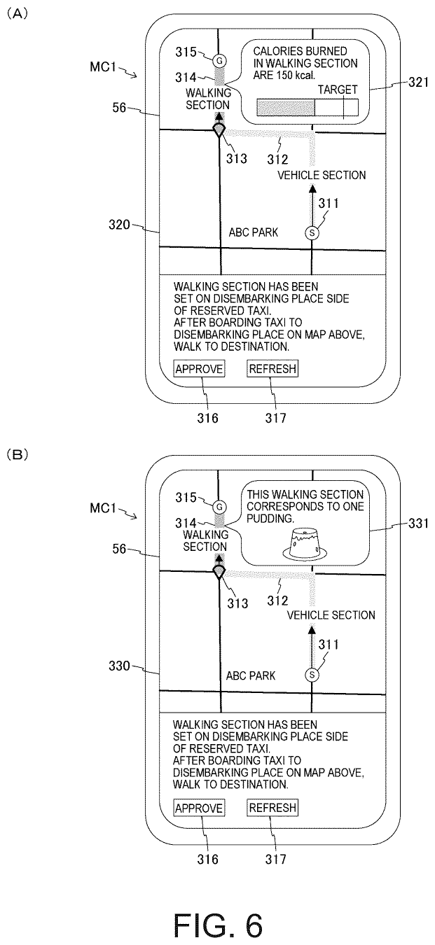

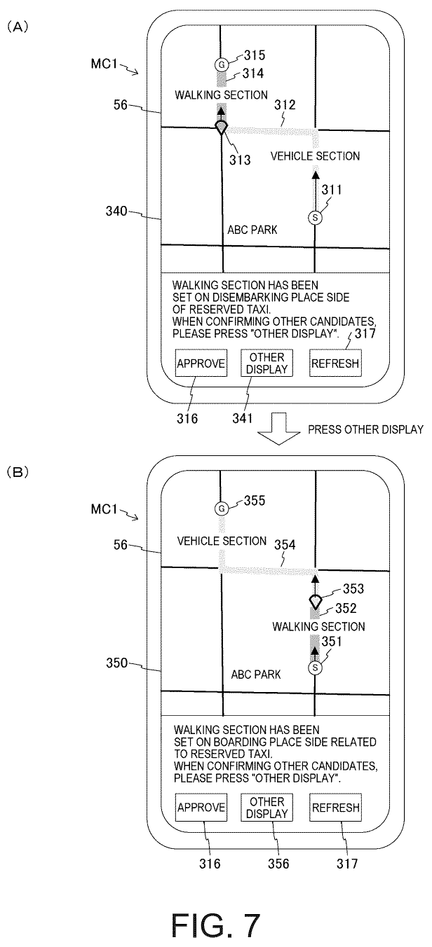

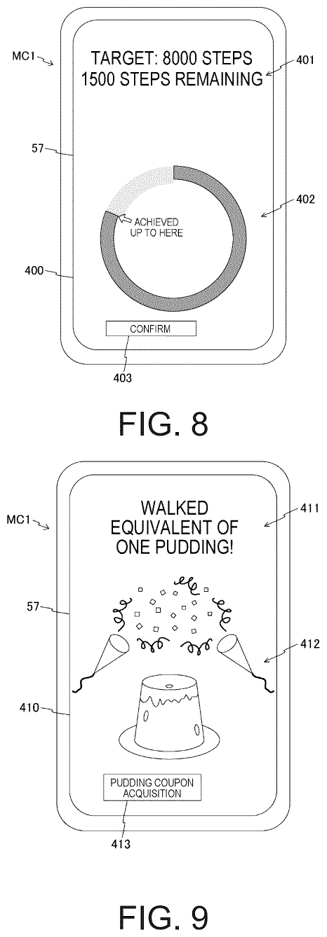

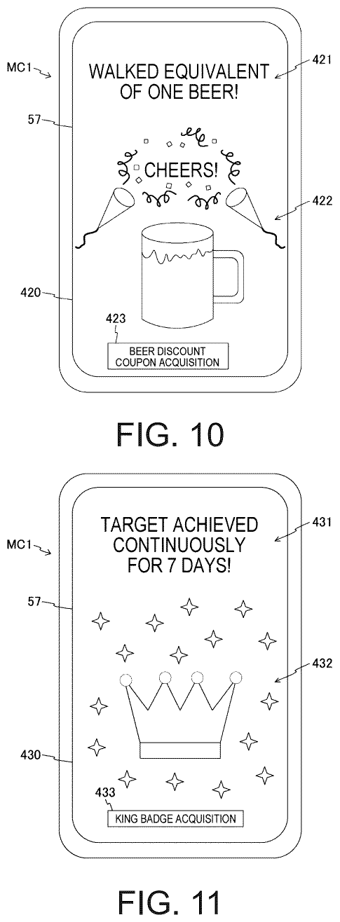

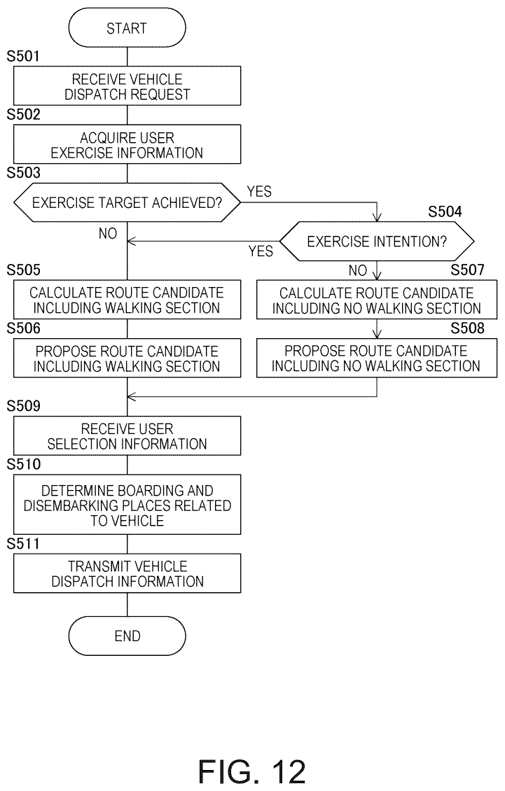

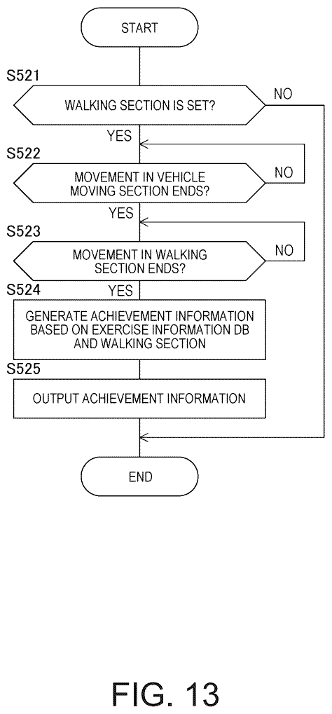

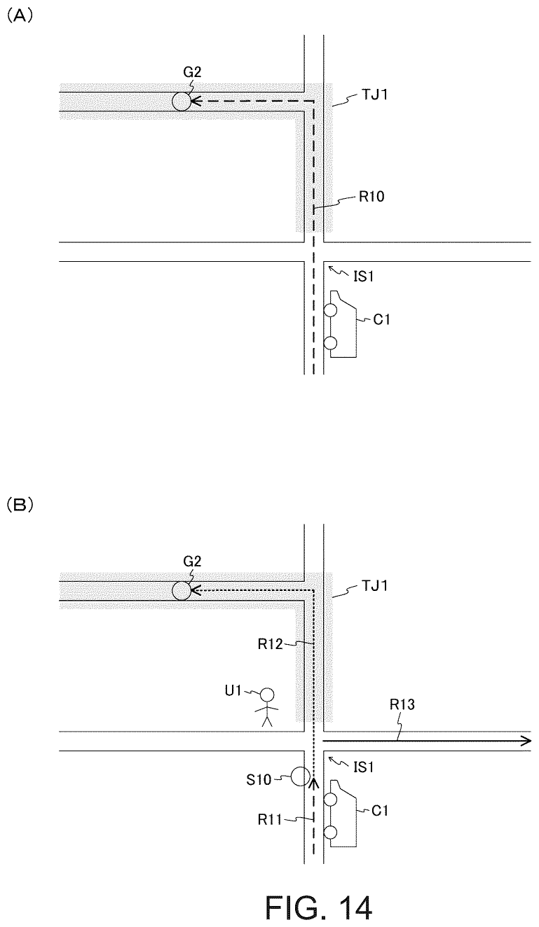

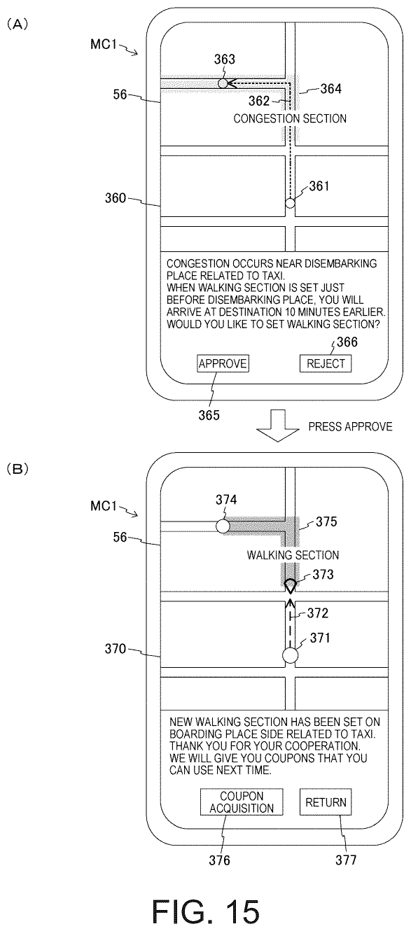

FIG. 15 is a diagram illustrating a display example of walking section setting screens 360 and 370 displayed on the input and output unit 56 when the congestion occurs near the disembarking place G2. Specifically, the walking section setting screen 360 and 370 for proposing a new walking section to the user U1 in response to the occurrence of congestion near the disembarking place G2 are shown.

As shown in FIG. 15(A), the control unit 52 of the electronic device MC1 displays, on the input and output unit 56, a walking section setting screen 360 for proposing a new walking section to the user U1 based on the information transmitted from the management server 100.

On the walking section setting screen 360, a current place marker 361 indicating the current place of the vehicle, a disembarking place marker 363 indicating a disembarking place, and a movement route marker 362 indicating a movement route from the current place of the vehicle to the disembarking place are displayed. On the walking section setting screen 360, a congestion section marker 364 indicating a congestion section in a road around the vehicle is displayed. For example, on the map, the movement route marker 362 can be displayed by a dotted arrow, and the congestion section marker 364 can be highlighted with a thick band.

In a lower display region of the walking section setting screen 360, an approval button 365 for approving a message content displayed in the lower display region, that is, the setting of a new walking section, and a rejection button 366 for rejecting the message content are displayed. When the rejection button 366 is pressed, the movement of the vehicle in the vehicle moving section is continued without setting a new walking section.

When the approval button 365 is pressed, a walking section setting screen 370 for notifying a new walking section is displayed as shown in FIG. 15(B).

On the walking section setting screen 370, a current place marker 371 indicating the current place of the vehicle, a disembarking place marker 373 indicating a disembarking place, and a movement route marker 372 indicating a movement route from the current place of the vehicle to the disembarking place are displayed. Further, on the walking section setting screen 370, a walking section end point marker 374 indicating an end point of a newly set walking section and a walking section marker 375 indicating the newly set walking section are displayed. For example, on the map, the movement route marker 372 can be displayed by a dotted arrow, and the walking section marker 375 can be highlighted with a thick band. Since a start point of the newly set walking section corresponds to the disembarking place, the start point is the location of the disembarking place marker 373. In addition, since the end point of the newly set walking section corresponds to an original disembarking place, the end point is the location of the disembarking place marker 363 (see FIG. 15(A)). The technique related to the movement assistance for assisting the movement of the user U1 toward the destination is the same as the examples shown in FIGS. 5 to 7, and thus the description thereof is omitted here.

In a lower display region of the walking section setting screen 370, a coupon acquisition button 376 for acquiring a coupon given according to the setting of a new walking section and a return button 377 for returning to the previous screen are displayed together with a message indicating that a new walking section had been set. When the coupon acquisition button 376 is pressed, some incentive is given as a reward for cooperating in a smooth operation of the vehicle dispatch service. For example, a discount ticket for the next use of the vehicle dispatch service, a discount ticket for the current use, or the like is given.

FIGS. 14 and 15 show the examples in which, at the time of vehicle dispatch reservation, the walking section is set before the vehicle moving section or no walking section is set. However, similarly, when the walking section is set after the vehicle moving section, a new walking section may be set based on the congestion section. In this case, the walking section after the vehicle moving section set at the time of the vehicle dispatch reservation is extended. Therefore, since a walking section that exceeds the upper limit value 207 per time (see FIG. 3) of the exercise information DB 200 is set, when the walking section that exceeds the upper limit value 207 per time is newly set, it is preferable to execute processing of confirming the fact to the user.

### Operation Example of Route Resetting Processing

FIG. 16 is a flowchart illustrating an example of route resetting processing in the management server 100. The route resetting processing is executed based on a program stored in the storage unit 130. The route resetting processing is executed for the user for whom the vehicle is arranged by the vehicle dispatch processing shown in FIG. 12. The route resetting processing will be described with reference to FIGS. 1 to 15 as appropriate.

In step S531, the vehicle dispatch processing unit 121 acquires surrounding road information including the vehicle moving section of the vehicle arranged in step S511 (see FIG. 12) from an external device. For example, the vehicle dispatch processing unit 121 periodically receives and acquires road information from a road server via the communication unit 110.

In step S532, the route setting unit 122 determines whether the congestion has occurred in the vehicle moving section of the vehicle arranged in step S511 (see FIG. 12). When the congestion has occurred in the vehicle moving section, the processing proceeds to step S533. On the other hand, when the congestion has not occurred in the vehicle moving section, the operation of the route resetting processing ends.

In step S533, the route setting unit 122 searches for a vehicle route again in which a section including a part of a section (congestion section) in which the congestion has occurred in the vehicle moving section is set as a walking section. In this case, as shown in FIG. 14(B), the route setting unit 122 searches for the vehicle route again such that the congestion section is set as the walking section.

In step S534, the route setting unit 122 compares, in a route to the disembarking place determined in step S510 (see FIG. 12), a moving time (vehicle moving time) when moving through the entire route by vehicle and a moving time (walking time) when walking through the walking section determined in step S533. The moving time by vehicle can be calculated based on a moving distance, a congestion situation, and the like. The moving time on foot can be calculated based on a moving distance, a walking speed, and the like.

In step S535, the route setting unit 122 determines whether a value (difference value) obtained by subtracting the walking time from the vehicle moving time, which is obtained by comparison in step S534, is equal to or smaller than a predetermined value. For example, when the difference value is equal to or less than a few minutes, it is considered preferable for the user to set a walking section and move through the congestion section on foot. Therefore, when the difference value is equal to or smaller than the predetermined value, the processing proceeds to step S536. On the other hand, when the difference value exceeds the predetermined value, the operation of the route resetting processing ends.

In step S536, the vehicle dispatch processing unit 121 transmits the route information including the route candidate (including boarding or disembarking place candidates) searched for again in step S533 to the electronic device MC1 of the user U1 who is boarding the vehicle arranged in step S511 (see FIG. 12). That is, the vehicle dispatch processing unit 121 transmits the route information including the route candidate searched for again in step S533 to the electronic device MC1 and displays the route candidate on the electronic device MC1, thereby proposing the route candidate to the user U1. For example, as shown in FIG. 15(A), the walking section setting screen 360 including a message indicating that the congestion has occurred and information for confirming the setting of a new walking section is displayed on the input and output unit 56 of the electronic device MC1.

The user U1 performs an approval operation to approve the proposal of the walking section setting screen 360 displayed on the input and output unit 56 of the electronic device MC1. When the approval operation is performed, the control unit 52 of the electronic device MC1 transmits approval information corresponding to the approval operation to the management server 100.

In step S537, the vehicle dispatch processing unit 121 determines whether approval information indicating that the user approves the content reproposed in step S536 is received. When the approval information is received, the processing proceeds to step S538. On the other hand, when the approval information is not received, that is, when the rejection information is received, the operation of the route resetting processing ends. In this case, the user is notified that the movement by vehicle is continued without setting a new walking section.

In step S538, the route setting unit 122 changes the disembarking place determined in step S510 to determine a new boarding or disembarking place (see FIG. 12). That is, the vehicle dispatch processing unit 121 determines the route candidate (including boarding or disembarking place candidates) reproposed in step S536 as a new route, and newly determines the boarding or disembarking places related to the vehicle corresponding to the route.

In step S539, the vehicle dispatch processing unit 121 transmits the vehicle dispatch information including the boarding or disembarking places newly determined in step S538 to the electronic device MC1 of the user U1 who is boarding the vehicle arranged in step S511 (see FIG. 12). The vehicle dispatch processing unit 121 transmits the vehicle dispatch information including the boarding or disembarking places determined newly in step S538 to the communication device of the vehicle. The vehicle dispatch processing unit 121 gives an incentive to the user U1. That is, the vehicle dispatch processing unit 121 gives an incentive to the user U1 who has approved the setting of a new walking section when the congestion has occurred in the movement route of the vehicle to the destination.

In this example, when a value (difference value) obtained by subtracting the walking time from the vehicle moving time in the congestion section is equal to or smaller than a predetermined value, a new route candidate including a new walking section is reproposed. However, the vehicle moving time in the congestion section and the walking time in the congestion section may be provided to the user in a comparable state, and a new route candidate including a new walking section may be determined based on a confirmation operation by the user.

In this way, in the congestion section, by setting a new walking section, it is possible to achieve the exercise target earlier and avoid the annoyance of waiting in the vehicle in congestion. By walking through the congestion section, it is possible to avoid the congestion and also contribute to improvement of health. Further, by setting a new walking section, it is possible to obtain some incentive, which serves as a new motivation for walking. Since the vehicle can avoid the congestion, the vehicle dispatch efficiency in the vehicle dispatch service can be enhanced.

### Example of Changing Service Content Based on Environment or the Like

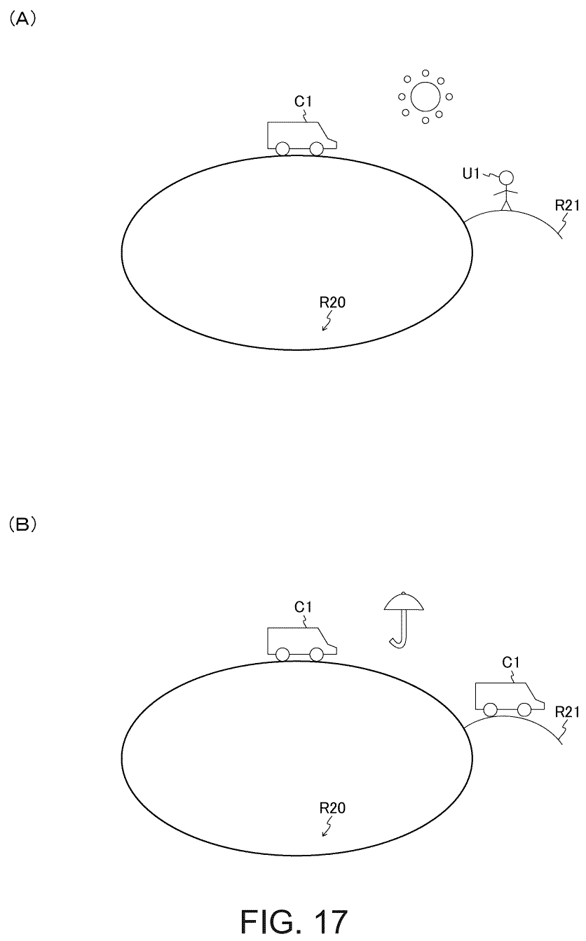

FIG. 17 is a diagram illustrating an example when a service content of the vehicle dispatch service is changed based on an environment or the like. In FIG. 17, in the vehicle dispatch service, a specific section in which transportation is performed with high efficiency is referred to as a hub section R20, and an individual transportation section extending from the hub section R20 is referred to as a spoke section R21. The hub section R20 and the spoke section R21 are names for distinguishing different transport sections according to movement characteristics, and the names may be appropriately changed according to the combination of transport sections.

For example, when the user selects the spoke section R21 as a walking section, the hub section R20 can be a section in which the vehicle of the vehicle dispatch service can operate with high transport efficiency. FIG. 17 shows an example in which the hub section R20 is simplified to be annular, but the annular hub section R20 is merely schematic and does not mean that the vehicle actually rotates around the annular hub section R20. For example, it is conceivable that a general main road is defined as the hub section R20, and a narrow alley that leads off from the main road is defined as the spoke section R21. In such a case, in the vehicle dispatch service described in the present embodiment, the spoke section R21 is proposed as a walking section, but it is also assumed that some users want to travel through the spoke section R21 by vehicle. However, in the spoke section R21, it is assumed that the transport efficiency of the vehicle of the vehicle dispatch service decreases. Therefore, when the spoke section R21 is set as the vehicle moving section, it is conceivable to generate a higher additional fee than when the hub section R20 is set as the vehicle moving section. For example, it is possible to set a normal fee for the hub section R20, which has high transport efficiency, and a higher fee than the normal fee for the spoke section R21, which is an individual transport section.

FIG. 17(A) shows a case where the weather around the hub section R20 and the spoke section R21 is sunny. In this case, it is preferable to propose the spoke section R21 as a walking section to the user by setting a normal fee for the hub section R20 and a higher fee than the normal fee for the spoke section R21.

FIG. 17(B) shows a case where the weather around the hub section R20 and the spoke section R21 is rainy. In this way, on the rainy day, when the spoke section R21 is set as a walking section, the use willingness of the user may be reduced. Therefore, on the rainy day, by setting a normal fee for the hub section R20 and setting a fee same as the normal fee or a fee close to the normal fee for the spoke section R21, the use willingness of the user can be increased.

As shown in FIG. 17(A), for example, if there is little hindrance to exercise, it is considered reasonable to charge an additional fee for continuing to board the vehicle without doing exercise. On the other hand, as shown in FIG. 17(B), for example, in an environment in which the user does not want to walk, in a case where the same fee system as that when the condition is satisfied is set, the use willingness of the user may be reduced, and the user may abandon the vehicle dispatch service. Therefore, it is preferable to set an appropriate fee so that the user can move to a place near the destination of the user by vehicle on the rainy day.

In this way, a service fee based on a difference between walking adoption rates is adapted according to the environmental conditions such as weather. That is, the service fee can be changed depending on the weather.

In addition, the incentive to be given to the user may be changed according to the environmental conditions such as weather. For example, as shown in FIG. 17(A), in which there is little hindrance to exercise, a low incentive is given in the environment. On the other hand, as shown in FIG. 17(B), in the environment in which the user does not want to walk, a high incentive is given. In this way, by changing the incentive to be given to the user according to the environmental conditions such as the weather, it is possible to direct the user who has the intention to actively exercise even on the rainy day. In addition, it is possible to make the user feel attractive about the fact that a high incentive is given by walking on a rainy day. That is, it is possible to encourage the user to walk by increasing the incentive when the condition is disadvantageous. Further, even for a user who walks on a sunny day but does not want to walk on a rainy day, it is possible to encourage the user to actively exercise on a sunny day, and it is possible to make the user feel attractive about the fact of receiving a low incentive without walking on a rainy day.

For example, the vehicle dispatch processing unit 121 determines a walking section in which the walking environment is deteriorated, based on at least one of the road environment on the route from the departure place to the destination, the exercise environment on the route, and the weather environment on the route. The road environment and the exercise environment mean the condition of roads on the route, the condition of roads on which the user walks, and the like. When the walking section in which the walking environment is deteriorated is selected by the user, the vehicle dispatch processing unit 121 can give an incentive to the user. Similarly, the vehicle dispatch processing unit 121 determines that the walking condition of the user is deteriorated based on at least one of the road environment on the route from the departure place to the destination, the exercise environment on the route, and the weather environment on the route. In a case where the walking section is selected by the user when the walking condition of the user is deteriorated, the vehicle dispatch processing unit 121 can give an incentive to the user.

In this way, it is possible to change the fee setting of the vehicle dispatch service or change an incentive to be given to the user according to environmental conditions such as weather.

### Setting Example of Exercise Section Other Than Walking Section

In the example described above, the walking section is set before and after the vehicle moving section. However, an exercise section may be set in which a moving means other than walking is used as the moving means for a user to exercise. For example, jogging and bicycles may be considered as the moving means other than walking. For example, it is conceivable that the user moves through a section set as a walking section by jogging. In this case, it is possible to determine that the user is jogging by using the electronic device MC1 or another device, for example, a health tracker. For example, a moving speed of the user can be calculated based on detection values acquired by the location information acquisition unit 54 and the acceleration sensor 55 of the electronic device MC1, and thus it is possible to determine that the user is jogging based on the moving speed. In a case where the user wears the health tracker, it is possible to estimate that the user is jogging based on the heart rate, pulse rate, and the like that can be acquired from the health tracker. For example, it is possible to calculate a change in the exercise amount of the user using a change in the heart rate and the pulse rate. Therefore, based on the change in the exercise amount, it is possible to determine that the user is jogging. Similarly, it is possible to determine that the user is moving by bicycle by using the electronic device MC1 or another device, for example, a health tracker. The calories burned when jogging or cycling can be calculated based on a moving distance, a moving speed, and the like of the user.

As described above, the user can jog through the walking section. However, in order to set a user moving section as a bicycle section, there need to be a bicycle available at a start point of the bicycle section, and a place where the bicycle is returned to an end point of the bicycle section.

For example, when a bicycle owned by the user is used, a section in which a place where the bicycle is placed, for example, a bicycle parking lot is used as a start point, and a place where the bicycle is placed, for example, home is set as an end point may be set as the bicycle section.

In addition, for example, it is assumed that a shared cycle system is used in which a bicycle can be shared and can be rented and returned at stations. In this case, a section in which a station of a shared cycle is set as a start point and another station of the shared cycle is set as an end point can be set as the bicycle section.

Here, it is also assumed that there is no station of the shared cycle in a route candidate between a departure place and a destination. In such a case, when there is the station of the shared cycle in the vicinity of the route candidate, it is also possible to expand the route candidate to the vicinity thereof and set the bicycle section. That is, when there is the station of the shared cycle in the vicinity of the route candidate, the route candidate may be interpolated based on the station.

In the example described above, the vehicle dispatch processing, the achievement information output processing, the route resetting processing, and the like are executed in the management server 100, but all or part of each processing may be executed in other devices. In this case, the information processing system is implemented by each device that executes a part of each processing. For example, at least a part of each processing can be executed using devices available to the user U1 (for example, a smartphone, a tablet terminal, a personal computer, a car navigation device, an in-vehicle infotainment (IVI)), various information processing devices such as servers connectable via a predetermined network such as the Internet, and various electronic devices.

A part (or all) of an information processing system capable of executing the function of the management server 100 may be provided by an application that may be provided via a predetermined network such as the Internet. This application is, for example, Software as a Service (SaaS).

### Configuration Example and Effects of Present Embodiment

The management server 100 is an information processing device that executes vehicle dispatch processing for the user U1. The management server 100 includes: the communication unit 110 (example of an reception unit) configured to receive at least one of a departure place and a destination from the user U1; the control unit 120 (route setting unit 122) configured to set, based on at least one of the received departure place and the received destination, a boarding place and a disembarking place related to a vehicle to be assigned to the user U1; and the communication unit 110 (example of an output unit) configured to output the boarding place and the disembarking place to the user U1, in which the control unit 120 (route setting unit 122) sets, based on exercise information related to the user U1, at least one of a first exercise section in which the user U1 moves while doing exercise with the boarding place as an end point and a second exercise section in which the user U1 moves while doing exercise with the disembarking place as a start point. For example, as shown in (B) to (D) of FIG. 4, the walking sections WS2 to WS5 are set before and after the vehicle moving sections VS2 to VS4.

With this configuration, when the user U1 moves using the vehicle dispatch service, the exercise section is set as necessary, and the opportunity to walk is increased to eliminate the lack of exercise. Accordingly, it is possible to achieve both the convenience of movement and the health of the user, and it is possible to enhance the richness of the user U1 who is in life using the vehicle.

The control unit 120 (route setting unit 122) sets, in a route from the departure place to the destination, a vehicle moving section from the boarding place to the disembarking place and at least one of the first exercise section before the vehicle moving section and the second exercise section after the vehicle moving section.

With this configuration, the first exercise section and the second exercise section can be set in the route from the departure place to the destination, and thus the opportunity to walk is increased to eliminate the lack of exercise by using the route taken by the user when moving.

The exercise information described in the present embodiment is information indicating a relationship between a target exercise amount and a today exercise amount of the user U1. The control unit 120 (route setting unit 122) sets at least one of the first exercise section and the second exercise section based on the relationship between the target exercise amount and the today exercise amount.

With this configuration, the exercise section can be set using the relationship between the target exercise amount and the today exercise amount of the user U1, and thus it is possible to set an appropriate exercise section according to the user U1.

The control unit 120 (route setting unit 122) sets at least one of the first exercise section and the second exercise section based on at least one of a road environment on a route from the departure place to the destination, an exercise environment on the route, a weather environment on the route, and a priority related to a location of an exercise section set by the user U1.

With this configuration, it is possible to set an appropriate exercise section according to the environment around the user U1 and the priority set by the user U1.

The communication unit 110 (example of the output unit) outputs a candidate of the first exercise section and a candidate of the second exercise section to the user U1. The communication unit 110 (example of the reception unit) receives selection information related to a selection operation of selecting a candidate desired by the user U1 from the candidate of the first exercise section and the candidate of the second exercise section. The control unit 120 (route setting unit 122) determines an exercise section to be set for the user U1 from the candidate of the first exercise section and the candidate of the second exercise section based on the selection information.

With this configuration, the user U1 can select a desired candidate, and thus it is possible to set an appropriate exercise section according to the user U1.

The control unit 120 (exercise information management unit 123) generates first information related to an exercise amount of the user U1 assumed by setting the first exercise section and second information related to an exercise amount of the user U1 assumed by setting the second exercise section. The communication unit 110 (example of the output unit) outputs at least one of the first information associated with the first exercise section and the second information associated with the second exercise section to the user U1. For example, as shown in FIG. 7, the information related to the exercise amount of the user U1 is displayed in the callout regions 321 and 331.

With this configuration, the user U1 can easily grasp the information related to the exercise amount of the user U1 assumed by setting the exercise section.

The control unit 120 (exercise information management unit 123) provides an incentive to the user U1 based on an exercise amount of the user U1 assumed based on exercise in at least one exercise section of the first exercise section and the second exercise section.

With this configuration, it is possible to improve motivation and satisfaction of the user U1 who uses the vehicle dispatch service.

In a case where a congestion occurs in a movement route of the vehicle to the destination, the control unit 120 (route setting unit 122) compares a walking time of the user U1 when the second exercise section is set and a moving time of the vehicle when the second exercise section is not set, and newly sets the second exercise section when a difference value between the walking time of the user U1 and the moving time of the vehicle satisfies a predetermined condition.

With this configuration, in the congestion section, by setting a new exercise section, it is possible to achieve the exercise target earlier and avoid the annoyance of waiting in the vehicle in congestion. Since the vehicle can avoid the congestion, the vehicle dispatch efficiency in the vehicle dispatch service can be enhanced.

In the case where the congestion occurs in the movement route of the vehicle to the destination, the control unit 120 (vehicle dispatch processing unit 121) provides an incentive to the user U1 when a new second exercise section is set.

With this configuration, by setting a new exercise section, it is possible to obtain some incentive, which serves as a new motivation for walking.

The control unit 120 (vehicle dispatch processing unit 121) determines, based on at least one of the road environment on the route from the departure place to the destination, the exercise environment on the route, and the weather environment on the route, an exercise section in which an exercise environment is deteriorated from the first exercise section and the second exercise section, and provides an incentive to the user U1 when the exercise section in which the exercise environment is deteriorated is selected by the user U1.

With this configuration, by selecting the exercise section in which the exercise environment is deteriorated, it is possible to obtain some incentive, which provides motivation to walk in the exercise section in which the exercise environment is deteriorated.

The control unit 120 (vehicle dispatch processing unit 121) determines that an exercise condition of the user U1 is deteriorated based on at least one of the road environment on the route from the departure place to the destination, the exercise environment on the route, and the weather environment on the route, and provides an incentive to the user U1 in a case where at least one of the first exercise section and the second exercise section is selected by the user U1 when the exercise condition of the user U1 is deteriorated.

With this configuration, by selecting the exercise section when the exercise condition of the user U1 is deteriorated, it is possible to obtain some incentive, which provides motivation to walk in the exercise section in which the exercise condition is deteriorated.

The information processing method according to the present embodiment is an information processing method for executing vehicle dispatch processing for the user U1. The information processing method includes: reception processing of receiving at least one of a departure place and a destination from the user U1 (step S501); setting processing of setting, based on at least one of the received departure place and the received destination, a boarding place and a disembarking place related to a vehicle to be assigned to the user U1 (steps S505, S507); and output processing of outputting the boarding place and the disembarking place to the user U1 (steps S506, S508), in which in the setting processing (step S505), at least one of a first exercise section in which the user U1 moves while doing exercise with the boarding place as an end point and a second exercise section in which the user U1 moves while doing exercise with the disembarking place as a start point is set based on exercise information related to the user U1. The program according to the present embodiment is a program for causing a computer to execute each processing.

With this configuration, when the user U1 moves using the vehicle dispatch service, the exercise section is set as necessary, and the opportunity to walk is increased to eliminate the lack of exercise. Accordingly, it is possible to achieve both the convenience of movement and the health of the user, and it is possible to enhance the richness of the user U1 who is in life using the vehicle.

Each processing procedure described in the present embodiment is an example for implementing the present embodiment, and an order of a part of each processing procedure may be changed within the scope of implementing the present embodiment, or a part of each processing procedure may be omitted or other processing procedures may be added.

Each processing described in the present embodiment is executed based on a program for causing a computer to execute each processing procedure. Therefore, the present embodiment can be understood as an embodiment of a program that implements a function of executing each processing and a recording medium that stores the program. For example, the program can be stored in a storage device of the information processing device by performing update processing for adding a new function to the information processing device. Accordingly, it is possible to cause the updated information processing device to execute each processing described in the present embodiment.

Although the embodiment of the present invention has been described above, the above embodiment is merely a part of application examples of the present invention, and is not intended to limit the technical scope of the present invention to the specific configurations of the above embodiment.

The present application claims priority under Japanese Patent Application No. 2022-088968 filed to the Japan Patent Office on May 31, 2022, and the entire content of this application is incorporated herein by reference.

1. An information processing device that executes vehicle dispatch processing for a user, the information processing device comprising:
a reception unit configured to receive a departure place and a destination from the user;
a route setting unit configured to set, based on the received departure place and the received destination, a route candidate in which a boarding place and a disembarking place related to a vehicle to be assigned to the user, and an exercise section in which the user moves while doing exercise are determined;
an output unit configured to output the route candidate to the user; and
a determination unit configured to determine a final boarding place and a final disembarking place based on a selection operation of the user, wherein
the route setting unit;
determines whether an exercise target of the user is achieved based on exercise information related to the user,
calculates a first route candidate as the route candidate when it is determined that the exercise target is achieved,
where in the first route candidate, only a vehicle moving section is determined by making the boarding place coincide with the departure place and the disembarking place with the destination, and
calculates a second route candidate, a third route candidate, and a fourth route candidate as the route candidate when it is determined that the exercise target is not achieved,
where in the second route candidate, the boarding place different from the departure place is set, and a first exercise section is determined between the departure place and the boarding place,
in the third route candidate, the disembarking place different from the destination is set, and a second exercise section is defined between the disembarking place and the destination, and
in the fourth route candidate, both the first exercise section and the second exercise section are determined,
the output unit
outputs the first route candidate to the user when the exercise target is achieved, and
outputs the second route candidate, the third route candidate, and the fourth route candidate to the user when the exercise target is not achieved, and
the determination unit
determines the boarding place and the disembarking place corresponding to the first route candidate when the selection operation of the user is detected in a case where the exercise target is achieved, and
determines the boarding place and the disembarking place corresponding to any one of the second route candidate, the third route candidate, and the fourth route candidate with reference to the selection operation of the user when the exercise target is not achieved.

2. (canceled)

3. The information processing device according to claim 1, wherein
the exercise information is information indicating a relationship between a target exercise amount and a today exercise amount of the user, and
the route setting unit determines whether the exercise target is achieved based on a comparison result between the target exercise amount and the today exercise amount.

4. (canceled)

5. (canceled)

6. The information processing device according to claim 1, wherein
the route setting unit generates first information related to an exercise amount of the user assumed by setting the first exercise section and second information related to an exercise amount of the user assumed by setting the second exercise section, and
the output unit outputs at least one of the first information associated with the first exercise section and the second information associated with the second exercise section to the user.

7. The information processing device according to claim 1, wherein
the route setting unit provides an incentive to the user based on an exercise amount of the user assumed based on exercise in at least one exercise section of the first exercise section and the second exercise section.

8. The information processing device according to claim 1, wherein
in a case where a congestion occurs in a movement route of the vehicle to the destination, the route setting unit compares a walking time of the user when the second exercise section is set and a moving time of the vehicle when the second exercise section is not set, and newly sets the second exercise section when a difference value between the walking time of the user and the moving time of the vehicle satisfies a predetermined condition.

9. The information processing device according to claim 8, wherein
in the case where the congestion occurs in the movement route of the vehicle to the destination, the route setting unit provides an incentive to the user when a new second exercise section is set.

10. (canceled)

11. (canceled)

12. An information processing method for executing vehicle dispatch processing for a user, the information processing method comprising:
reception processing of receiving at least one of a departure place and a destination from the user;
route setting processing of calculating, based on the received departure place and the received destination, a route candidate in which a boarding place and a disembarking place related to a vehicle to be assigned to the user, and an exercise section in which the user moves while doing exercise are determined;
output processing of outputting the route candidate to the user; and
determination processing of determining a final boarding place and a final disembarking place based on a selection operation of the user, wherein
in the route setting processing,
whether an exercise target of the user is achieved is determined based on exercise information related to the user,
a first route candidate is calculated as the route candidate when it is determined that the exercise target is achieved,
where in the first route candidate, only a vehicle moving section is determined by making the boarding place coincide with the departure place and the disembarking place with the destination, and
a second route candidate, a third route candidate, and a fourth route candidate are calculated as the route candidate when it is determined that the exercise target is not achieved,
where in the second route candidate, the boarding place different from the departure place is set, and a first exercise section is determined between the departure place and the boarding place,
in the third route candidate, the disembarking place different from the destination is set, and a second exercise section is defined between the disembarking place and the destination, and
in the fourth route candidate, both the first exercise section and the second exercise section are determined,
in the output process,
the first route candidate is output to the user when the exercise target is achieved, and
the second route candidate, the third route candidate, and the fourth route candidate are output to the user when the exercise target is not achieved, and
in the determination process,
the boarding place and the disembarking place corresponding to the first route candidate are determined when the selection operation of the user is detected in a case where the exercise target is achieved, and
the boarding place and the disembarking place corresponding to any one of the second route candidate, the third route candidate, and the fourth route candidate are determined with reference to the selection operation of the user when the exercise target is not achieved.

13. A non-transitory computer readable medium storing a program for causing a computer to execute vehicle dispatch processing for a user, the program for causing the computer to execute:
reception processing of receiving at least one of a departure place and a destination from the user;
route setting processing of calculating, based on the received departure place and the received destination, a route candidate in which a boarding place and a disembarking place related to a vehicle to be assigned to the user, and an exercise section in which the user moves while doing exercise are determined;
output processing of outputting the route candidate to the user; and
determination processing of determining a final boarding place and a final disembarking place based on a selection operation of the user, wherein
in the route setting processing,
whether an exercise target of the user is achieved is determined based on exercise information related to the user,
a first route candidate is calculated as the route candidate when it is determined that the exercise target is achieved,
where in the first route candidate, only a vehicle moving section is determined by making the boarding place coincide with the departure place and the disembarking place with the destination, and
a second route candidate, a third route candidate, and a fourth route candidate are calculated as the route candidate when it is determined that the exercise target is not achieved,
where in the second route candidate, the boarding place different from the departure place is set, and a first exercise section is determined between the departure place and the boarding place,
in the third route candidate, the disembarking place different from the destination is set, and a second exercise section is defined between the disembarking place and the destination, and
in the fourth route candidate, both the first exercise section and the second exercise section are determined,
in the output process,
the first route candidate is output to the user when the exercise target is achieved, and
the second route candidate, the third route candidate, and the fourth route candidate are output to the user when the exercise target is not achieved, and
in the determination process,
the boarding place and the disembarking place corresponding to the first route candidate are determined when the selection operation of the user is detected in a case where the exercise target is achieved, and
the boarding place and the disembarking place corresponding to any one of the second route candidate, the third route candidate, and the fourth route candidate are determined with reference to the selection operation of the user when the exercise target is not achieved.

14. An information processing device that executes vehicle dispatch processing for a user, the information processing device comprising:
a reception unit configured to receive a departure place and a destination from the user;
a route setting unit configured to calculate, based on the received departure place and the received destination, a route candidate in which a boarding place and a disembarking place related to a vehicle to be assigned to the user, and an exercise section in which the user moves while doing exercise are determined;
a determination unit configured to determine a final boarding place and a final disembarking place according to the calculated route candidate; and
an output unit configured to output the determined boarding place and the determined disembarking place to the user, wherein
the route setting unit
determines whether an exercise target of the user is achieved based on exercise information related to the user,
calculates a first route candidate as the route candidate when it is determined that the exercise target is achieved,
where in the first route candidate, only a vehicle moving section is determined by making the boarding place coincide with the departure place and the disembarking place with the destination, and
selects and calculates any one of the second route candidate, the third route candidate, and the fourth route candidate as the route candidate based on at least one of a road environment on a route from the departure place to the destination, an exercise environment on the route, a weather environment on the route, and a priority related to a location of an exercise section set by the user when it is determined that the exercise target is not achieved,
where in the second route candidate, the boarding place different from the departure place is set, and a first exercise section is determined between the departure place and the boarding place,
in the third route candidate, the disembarking place different from the destination is set, and a second exercise section is defined between the disembarking place and the destination, and
in the fourth route candidate, both the first exercise section and the second exercise section are determined.

15. An information processing device that executes vehicle dispatch processing for a user, the information processing device comprising:
a reception unit configured to receive at least one of a departure place and a destination from the user;
a control unit configured to set, based on at least one of the received departure place and the received destination, a boarding place and a disembarking place related to a vehicle to be assigned to the user; and
an output unit configured to output the boarding place and the disembarking place to the user, wherein
the control unit sets, based on exercise information related to the user, at least one of a first exercise section in which the user moves while doing exercise with the boarding place as an end point and a second exercise section in which the user moves while doing exercise with the disembarking place as a start point, and
the control unit determines, based on at least one of the road environment on the route from the departure place to the destination, the exercise environment on the route, and the weather environment on the route, an exercise section in which an exercise environment is deteriorated from the first exercise section and the second exercise section, and provides an incentive to the user when the exercise section in which the exercise environment is deteriorated is selected by the user.

16. An information processing device that executes vehicle dispatch processing for a user, the information processing device comprising:
a reception unit configured to receive at least one of a departure place and a destination from the user;
a control unit configured to set, based on at least one of the received departure place and the received destination, a boarding place and a disembarking place related to a vehicle to be assigned to the user; and
an output unit configured to output the boarding place and the disembarking place to the user, wherein
the control unit sets, based on exercise information related to the user, at least one of a first exercise section in which the user moves while doing exercise with the boarding place as an end point and a second exercise section in which the user moves while doing exercise with the disembarking place as a start point, and
the control unit determines that an exercise condition of the user is deteriorated based on at least one of the road environment on the route from the departure place to the destination, the exercise environment on the route, and the weather environment on the route, and provides an incentive to the user in a case where at least one of the first exercise section and the second exercise section is selected by the user when the exercise condition of the user is deteriorated.
